(19) United States
(12) Patent Application Publication
(10) Pub. No.: US 2003/0172368 A1
(43) Pub. Date: Sep. 11, 2003

(54) System and method for autonomously generating heterogeneous data source interoperability bridges based on semantic modeling derived from self adapting ontology

(76) Inventors: Elizabeth Alumbaugh, El Dorado Hills, CA (US); Yuri Adrian Tijerino Bohorquez, Cameron Park, CA (US); Mary Elizabeth Bain, Nevada City, CA (US); Ronald Joseph Reynolds, Davis, CA (US); Steven John Rasmussen, Citrus Heights, CA (US); David Eugene Lucky, Orangevale, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/329,153

(22) Filed: Dec. 23, 2002

Related U.S. Application Data
(60) Provisional application No. 60/342,098, filed on Dec. 26, 2001.
(60) Provisional application No. 60/426,761, filed on Nov. 15, 2002.
(60) Provisional application No. 60/427,395, filed on Nov. 18, 2002.

(51) Int. Cl. G06F 9/44

(52) U.S. Cl. 717/106

(57) ABSTRACT

A system, including software components, that efficiently and dynamically analyzes changes to data sources, including application programs, within an integration environment and simultaneously re-codes dynamic adapters between the data sources is disclosed. The system also monitors at least two of said data sources to detect similarities within the data structures of said data sources and generates new dynamic adapters to integrate said at least two of said data sources. The system also provides real time error validation of dynamic adapters as well as performance optimization of newly created dynamic adapters that have been generated under changing environmental conditions.

### PRIORITY TO PRIOR PROVISIONAL APPLICATIONS

Priority is claimed to Provisional Applications Serial No. 60/342,098, filed on Dec. 27, 2001, No. 60/426,761 filed on Nov. 15, 2002 and No. 60/427,395 filed on Nov. 18, 2002.

### FIELD OF THE INVENTION

This invention relates to a system and method for efficiently and dynamically analyzing changes to software applications that exist within a systems integration environment containing multiple heterogeneous data sources; and for providing for the simultaneous data mapping, coding, and maintenance support of interfaces between multiple software applications in real time event driven actions.

### COPYRIGHT NOTICE

A portion of the disclosure of this patent document contains material which is protected by copyright. The copyright owner has no objection to the facsimile reproduction by anyone of this patent document, but otherwise reserves all copyright rights including, without limitation, making derivative works of the material protected by copyright.

### BACKGROUND OF THE INVENTION

Providing application integration between heterogeneous software applications, environments and data resources (data sources) requires some type of provision for transformation, format, interface, and data connectivity services. These services are provided by a collection of software components that are collectively called adapters. Adapters integrate software application and database resources so they can interoperate with other disparate data sources and applications. They provide the interface between the application and, with most current integration approaches, the messaging subsystems that connects to the various applications.

Historically adapters have been viewed as the weakest link in application integration. This is because adapters are built to specific versions of software, such as business or database applications, and are specific to the platform upon which those applications operate. Most integration adapters aren't reusable and virtually all require extensive manual customization and ongoing maintenance. Customization almost always adds unforeseen weeks and months to the integration effort and greatly increases the complexity, cost, and time required for adapter maintenance and support efforts. Yet customization is almost unavoidable as business rules and data transformation occurs within integration adapters. These issues are compounded whenever any of the software applications and data sources within the integration environment change.

Each time a data source is upgraded, patched, revised or customized the integration adapters between the modified application and all other applications within the integrated environment must be rewritten. Even relatively simple or minor modifications to mission-critical data sources require extensive manual effort to determine the impact of the revision on the integration environment. Prior to this invention a self-generating and auto repairing solution for building, maintaining and supporting integration adapters did not exist. The prior art for adapter development requires some form of manual user intervention/manipulation to build, maintain and/or support integration infrastructures. Integrating heterogeneous applications is accomplished through the use of a variety of software or hardware based “tools” wielded by highly technical software professionals. For example U.S. Pat. No. 6,016,394 requires the manual development and maintenance of a single monolithic database to address integration needs; U.S. Pat. No. 6,167,564 aggregates multiple integration tools from a variety of vendors within a single coherent development framework so that users only have to navigate one application (which is still manual) pertaining to building integration adapters; U.S. Pat. No. 6,308,178 allows the user to manipulate a graphically enhanced data mapping/code generation and wizard driven screen system that guides the process of configuring inputs, creating interface tables, naming source files, and adding custom integration options; U.S. Pat. No. 6,256,676 requires a user to use a series of middleware tools known as an Application Development Kit (ADK) to manually build integration adapters; U.S. Pat. No. 6,236,994 provides a method and apparatus for manually developing and managing a metadata taxonomy catalog containing the referential linkages of data between multiple heterogeneous documents and multiple heterogeneous data sources.

It has been estimated that from 60-80% of the annual $10.7B software integration market (year 2001-2002) is spent on manual adapter development, maintenance and support efforts rather than on software licensing. The majority of this cost is for the systems analysis, data mapping, hard coding and testing of integration adapters. When done manually, the transformations and validations needed for data integration can require significant developer time and effort. In fact, these tasks are often the cause of costly implementation delays and project overruns. Rapidly evolving business demands, combined with ever-tightening budgets and time constrains, mean that organizations need an integration adapter solution that can be disassociated from specific software applications, version and operating platforms. Additionally organizations need an effective integration platform that can dynamically and intelligently adjust to the reality of continuously morphing or changing applications and computing environments.

Managing change across software and database applications accounts for approximately 33% of a company's entire IT budget, according to some estimates. The majority of this cost is for detailed systems analysis required to understand the impact of product upgrades, revisions and patches on a company's existing computing infrastructure. Prior to this invention, this activity required manual significant effort, was inordinately expensive, time consuming and fraught with error. Users frequently upgraded an application only to find that management reports no longer functioned, integration adapters were compromised, or that the application itself has become unstable. The prior art falls short of these needs and requires months of manual effort including detailed systems analysis, large budgets, and long lead times, as well as additional maintenance and support expenses.

The object, therefore, of the present invention is to provide a system to efficiently, in terms of both time and resources, and dynamically, in terms of real time event driven actions, analyze changes to data sources, and dynamically, in terms of real time event driven actions, analyze changes to data sources within an integration environment and provide for simultaneous recoding of adapters between multiple heterogeneous data sources. In addition, the present invention intelligently analyzes the conceptual relationships and alternative data mapping strategies by utilizing intelligent computer programs that can analyze and adapt to structural, contextual and semantic differences between multiple data sources. It is a further object of the present invention to be disassociated from application specific platforms, business logic and coding structures that are inherent to the specific data source thereby allowing automatic supportability and maintainability of interoperability adapters that conforms to the specific requirements of the source systems. It is also an object of the present invention to provide real time error validation of dynamic adapters as well as performance optimization of newly created adapters that have been generated under changing environmental conditions while maximizing the use of existing integration infrastructures. One of the embodiments of the invention can help users gain control over data source change thus reducing the risk, time, costs and efforts associated with adapter maintenance and support allowing users to optimize the value of IT investments and establish governance, visibility and control.

### INTEGRATION ADAPTER REQUIREMENTS AND TYPES

Providing complete application integration between heterogeneous environments and resources requires the provision of the following services:

Data flow services to provide work and process flow flexibility that can reflect business processes;

Transformation services to provide data syntax resolution and validation management;

Format Services to provide schema and semantic messages;

Interface services to provide reconciliation and translation of interfaces including SQL, RPC, IDL, CGI, APIs, etc.;

Network services to provide such as queuing, multiplexing, ordering, routing, security, compression, and recovery; and

Connectivity services to provide such as TCP, HTTP, SOAP, CORBA, and SNA.

These services are provided by a collection of software components that exist within most integration environments. Adapters provide some of these services; transformation, format, interface and connectivity. Adapters connect software into the integration environment so that disparate applications and data stores can interoperate with other connected resources. There are many different techniques and approaches to achieving interoperability. Since many of these choices are complex, expensive and cumbersome the selected method should align with the companies long-term business needs without causing the business to lose its ability to quickly exploit opportunities created by new technologies.

There are five categories of adapters—application, language, environment, data, and middleware.

Application adapters tie disparate software systems together by mapping processes, workflows or functions from a source software program to a target application. Application adapters' use specialized “bridge” programs that are written so that one program can work with the data or the output from functions in another program. The result of this type of integration may be a new application with its own user interface or the capability of a desktop or mainframe application to handle data and includes capabilities borrowed from other applications.

Language adapters accomplish integration by mapping the syntax of one programming language with another (COBAL, RPC, C, Basic, IDL, Tcl, and others) so that older legacy software systems can connect to new applications using the same programming standards (JAVA, XML, COM, EJB, Visual Basic, and the like) that the more modern systems use to communicate with each other.

Environment adapters provide platform level integration by using standards such as CICS, SNA, and Mainframe OSI to provide connectivity.

Data adapters provide connectivity by mapping information between applications from flat files, data sources and database connections using the applications underlying data store (such as Oracle, Sybase, VSAM, and others) Data adapters tend to be used inside applications to provide tightly coupled synchronous access to heterogeneous databases intended for direct use, for which an application-level (API) interface is not preferred or doesn't exist. p1 Middleware adapters provide connectivity and interoperability by using specialized bridging applications that support application interoperability and data interchange. Middleware adapters use languages and protocols such as XML, FTP, MQ Series and ODBC to accomplish environmental connectivity, transapplication workflow, data mapping, and programmatic exchanges across applications that in turn initiates an event that causes additional programmatic actions.

Products that exist within each of the above listed adapter categories can be further segmented into the following types—static, intelligent, and dynamic.

A static adapter is one that is predefined; custom developed, both application and version specific, and provides basic application integration to a targeted resource. Static adapters provide very little, if any, data transformation, validation, or filtering; they simple shuttle data from one application to another in either real-time or batch transmission modes.

An intelligent adapter implements data manipulation, validation, and business rules processing by blending new applications and processes with existing systems. Intelligent adapters are aware of application metadata and they provide integration performance improvements by moving business rule processing from centralized integration brokers to the distributed application adapter, thus reducing network traffic. However, not all intelligent adapters are equal. Each one's functionality is directly controlled by the depth, breath and amount of application knowledge that has been encapsulated into the adapter by the supplier. Intelligent adapters reduce the amount of custom coding and application expertise required to support an integrated environment because they are designed to address the underlying business logic of version-specific products within the integrated environment. While labeled as “smart,” intelligent adapters usually fail to address application/database/logic customizations created by end user customers. Intelligent adapters require manual intervention and custom augmentation whenever an application is modified or upgraded.

A dynamic adapter has the advantages of an intelligent adapter with few, if any, of the weaknesses. It actually learns from performing its data manipulations and can change its behavior by detecting changes in a monitored application. A dynamic adapter is capable of sensing changes in the integrated environment; automatically re-programming itself once a change has been detected and finetunes its performance as the result of newly learned operational information. Only dynamic adapters can seamlessly function within all five of the above mentioned adapter categories without custom coding.

Our invention provides a novel system that overcomes the above shortcomings.

Accordingly, it is an object of the invention to monitor an application and to automatically detect changes in the application's database structure and record this information in a format such as XML format in a knowledge base repository.

It is another object of the invention to “learn” user preferences and data mapping criteria each time the application is used.

It is a further object the invention to automatically detect application changes, reducing the need for extensive database analysis.

It is yet a further object of the invention to use dynamic syntactic processes to create adapter maintenance and support plans automatically.

It is an additional object of the invention to significantly reduce the time and manpower required to plan, analyze, design, and generate an interoperability plan for applications.

It is another object of the invention to provide a system that automatically checks for errors in new adapters, minimizing the number of staff required for this task.

It is still another object of the invention to automatically maintain and support adapters, reducing the need for expensive integration programmers.

It is still an additional object of the invention to provide error management components that automatically test updated adapters before they are placed into a production environment.

It is a further object of the invention to automatically detect application changes, so that end users do not need an in-depth understanding of the structure of each application.

It is another object of the invention to generate programming code automatically, so that end users do not need to learn numerous interface programming languages.

### BRIEF DESCRIPTION OF THE DRAWINGS

FIG. 1 is a general representation of the overall system architecture useable in the invention.

FIG. 2 is an alternate illustration of the general operation of the invention, including processes associated with Assessment, Modification Planner, Hub, Error Validation and Code Generation components.

FIG. 3 illustrates some of the information collected by the Schema Manager, which information becomes the input for ontology generation.

FIG. 4 illustrates the steps for generating a change specification between to different instances of an application's schemas.

FIG. 5 illustrates the steps necessary to create an application ontology from an application schema

FIG. 6 illustrates the steps necessary to generate a similarity map between two disparate applications.

FIG. 7 illustrates the three main steps that go into planning an integration adapter.

In describing our invention we will be using terms used in the software and artificial intelligence technologies. Some of these terms, as used in this patent document, are defined below.

### DEFINITIONS

“Adapter” means software code that allows heterogeneous software applications and data sources to interoperate and share data with each other.

“Application Ontology Factory” means the concept engine that is responsible for the development of an Application Specific Ontology. The Application Ontology Factory is common and reusable across any application and in turn produces an application specific ontology (conceptual model that is an axiomatic characterization of data and meaning) for each monitored data source, by mapping application schema elements, relationships between those elements and other constraints to a common ontology.

“Application Program Interface (API)” means a series of functions that programs can use to make the operating system do a specific function. Using Windows APIs, for example, a program can open windows, files, and message boxes—as well as perform more complicated tasks—by passing a single instruction.

“Assessment Microagent” means an intelligent software program that can independently and in an event driven fashion analyze selected data sources (software applications and databases) thereby creating a point in time situation assessment and application specific concept model of the data source as well as a comparison record that shows the differences between two or more point-in-time snapshots of a data source.

“Change Specification File” means the record that represents the detailed summary attributes of information about differences between two or more specific point-in-time snapshots of an application which is inclusive of the data sources underlying schema.

“Change Specification Manager” means the mechanism that handles the persistence operations that are associated with retrieving and storage of multiple versions of change specifications files.

“Code Generator Agent” means an intelligent software program whose purpose is to generate interoperability adapter code from a generic Integration Plan to a specific implementation programming language selected by a human user.

“Common ontology” is a general purpose ontology that contains definitions for concepts and relationships among those concepts that have wide coverage among multiple domains. In the ontology community this is sometimes called the upper ontology.

“Communicator” means the graphic user interface that supports human interaction with all the systems microagents contained in the instant invention. The Communicator implicitly directs the various microagents to be responsive to the plans and goals of the human users.

“Concept Hierarchy” refers to concepts in an ontology and means the compendium of all concepts and relationships between those concepts as they define a given concept. In other words, “Concept Hierarchy” means all the more abstract concepts and their relationships used to define a concept in an ontology.

“Constraint” means an attribute of a table which restricts the values that a field can have. (e.g., NOT NULL, UNIQUE, etc.)

“Cyclic Redundancy Check” or “CRC” means an algorithm applied to a block of data which produces a number, typically 32-bits or more, which has a very high probability of being unique for that block of data. Note, this is more widely known as a “Message Digest” or “Hash” algorithm and for the record CRC's are used primarily to detect data transmission errors whereas hashes are used to determine uniqueness (though having duplicate CRC's for dissimilar blocks of data is also very unlikely and CRC's are typically faster to produce than hashes). Commonly used message digest algorithms include CRC-32, MD5, and SHA-1.

“Data Source” means any software system with a data structure such as a database, an enterprise application, or flat data files.

“Deployment Agent” means an intelligent software program whose purpose is to deploy newly generated adapter interoperability code to a user specified location such as a secured server using a deployment strategy that is identified by a system user. Deployment strategies may include File Transfer Protocol (FTP), file-copy, telnet and Secure Socket Shell (SSH).

“Document Type Definition” or “DTD” means a file used to validate the structure of an XML document. DTDs are used so that a validating XML parser can validate that the tag structure and attributes in an XML document are valid based on the rules laid out in the DTD.

“Dynamic” means performed when a program is running.

“Enterprise Application Integration (EAI)” means a method of integrating software applications that is workflow driven.

“Error Management Microagent” means an intelligent software program that evaluates newly created interoperability adapter code to detect errors in code generation, data extraction, aggregation and insertion or would hinder the software application programs to interoperate (process a transaction and exchange data).

“Event-Driven” means a trigger that allows a program to react independent of human intervention to changes that have occurred in a software environment.

“Event of Interest” means an event, such as a structure change in a table, that is of significance to the system.

“Extensible Markup Language (XML)” means a semantic-preserving markup language used for interchanging data between heterogeneous systems.

“Foreign Key” means a value stored in a table which is the Primary Key of another table. Used to create a reference between two tables, such as Person.addrld and Address.id.

“Global Ontology” is synonym with Common Ontology as defined above.

“Hub” means the central entry point into the system from external interfaces and from the GUI. The hub controls session management activities including user authentication, retaining information for a specific user about the time between logging in and logging out, and routing of user requests to the appropriate system components and routing of the results back to the requester.

“Immutability” means an inability to change. Immutable objects, once created, never change their value, which allows for certain assumptions and optimizations to be made when using them.

“Implementation Language” is a “programming” language in which an integration plan can be implemented. This includes languages such as Perl, Java, and so forth, but also languages such as XML which are not true programming languages per-se.

“Index” means a hash value calculated for a row based on fields within that row which can then be used for faster querying, such as creating an index of Person.LastName so that queries for Person records by LastName will be faster.

“Integration Validation” means performing an error check to determine the correctness of newly generated interoperability adapter code as well as ensuring that the newly generated code will not corrupt transported information or adversely impact the targeted data source, as well as other existing interoperability code structures.

“Interface” means a boundary across which two independent systems meet and act on or communicate with each other.

“Language Descriptor” is an object which describes a language in a form readable by software. A descriptor would include things like the name of the language, the statement-terminator character, the comment character, the string constant-delimiter, and so forth.

“Microagent” means an intelligent software program that can be viewed as perceiving its environment through sensors that communicate what should be accomplished and in turn act upon that environment through effectors which are software tools and services that dynamically determine how and where to satisfy the request.

“Micro Agent (software robots)” means intelligent software programs that use software tools and services on a person's behalf. Also known as softbots. Micro agents allow a person to communicate what they want accomplished and then dynamically determine how and where to satisfy the person's request.

“Modification Planning Microagent” means an intelligent software program that defines data mapping and interoperability operations between two or more application specific ontologies. The Modification Planning Micro Agent uses expert traces to dynamically synthesise transformation information between two or more ontologies by means of an inferance engine (algorithm) to develop a sequence of actions (plans) that will achieve concept mapping and data transformation conditions which are representitive of the ideal interoperability state required by the two or more application specific ontologies that exist within an integration enviornment.

“Ontological Comparative Knowledge Base” means the application specific Ontology that maintains information that pertains to a data source's infrastructure (Tables, Columns, Indexes, Foreign Keys, Triggers, Stored Procedures, Primary Keys, Other Constraints, Views, Aliases/Synonyms, etc.). The Assessment Microagent compares one point in time Ontological Comparative Knowledge Base to other point in time snapshots to determine if a change has occurred. Identified changes between two point-in-time versions of the Ontological Comparative Knowledge Base can be used to facilitate understanding, organizing, and formalizing information about the monitored data source supportive of the operational needs of the other micro agents.

“Ontology” means the specification of conceptualizations, used to help programs and humans share knowledge. In this usage, an ontology is a set of concepts—such as things, events, and relations—that are specified in some way (such as specific natural language) in order to create an agreed-upon vocabulary for exchanging information. “Ontology Editor” means the mechanism that allows editing of existing ontology settings including information on specific concepts and relationships of a common or application specific ontology.

“Ontology Manager” means the mechanism that manages the persistence operation associated with storage and retrieval of various versions of the common ontology, application ontologies and application-to-application ontology mappings.

“Open Database Connectivity (ODBC)” means a widely accepted application programming interface (API) for database access that makes it possible to access different database systems with a common language. ODBC is based on CLI (Call Level Interface). There are ODBC drivers and development tools for a variety of operating systems such as Windows, Macintosh, UNIX and OS/2.

“Persistence” means that the information stored in a view has to continue to exist even after the application that saved and manipulated the data presented in the view has ceased to run.

Persistence provides a mechanism for server-side components to create, read, update, and delete and store multiple versions of system data.

“Planner” means the intelligent software program that takes input from application specific ontology generation processes, understands the differences and similarities between two or more heterogeneous application specific ontologies and generates an integration plan that includes the detailed concept mapping and data transformation rules between heterogeneous applications.

“Polling” means querying a source on a recurring schedule, such as once every 10 minutes.

“Primary Key” or “PK” is an identifier which uniquely identifies a single instance of a particular type of object. (e.g., a SSN is a Primary Key for a U.S. citizen).

“Schema” means the logical organization or structure for representing data that exists in a database. Schema includes definitions and relationships of data and shows abstract representations of an object's characteristics and its relationships to other objects. This process is completed by evaluating the data source's metadata, meta-relationships inclusive of the basic notions of parenthood, integrity, identity, and dependence, etc., which in turn, are compiled into a tag library that becomes the foundation of an application specific Ontological Comparative Knowledge Base.

“Script Executor Microagent” means as the Code Generator Agent generates interoperability code from a generic Integration Plan to a specific implementation programming language selected by a human user, the Script Executor Microagent executes that code.

“State Machine” means a construct used to describe a flow of events given input and the results of the currently executed state within the machine. State-machines allow for very flexible sequencing and decoupling of their component parts to allow the user of the state-machine to alter and customize its behavior with a minimum of effort. State-machines are normally represented as a directional graph in which each node of the graph represents a state of the machine (“startup”, “login”, “ftp”, “done”, “failure”) and the branches within the graph represent the flow of control from state to state (‘success’ at the ‘login’ state results in a transition to the ‘ftp’ state, ‘failure’ at the ‘login’ state results in a transition to the ‘failure’ state, and so forth).

“Stored Procedure” means a compiled query stored on the database server and used for efficiency and encapsulation process.

“Structured Query Language (SQL)” means a scripting language used to communicate with a database.

“Synectics” means the human problem-solving process based on logical elimination of options and heuristic reasoning.

“Trigger” means an entity within a database which is notified when a specified event occurs, such as a row being added to a table.

“Validating XML Parser” means a parser that, when parsing XML, validates both that the XML is well formed and that the XML is valid based on the rules specified in a specified DTD or XML-Schema file.

“WordNet” means a specific online lexical database of the English language, which is maintained by the Cognitive Science Laboratory at Princeton University. The WordNet is commonly used in the computer science field to compare words based on their meanings.

“Use case” means a formal description of a particular functionality or behavior that the system displays for specific situations.

“View” means a “fake” table normally composed of data from various tables which appears to the user as a regular database table, such as a consolidated view showing data from both Person and Address data in a single table.

“XML (Extensible Markup Language)” means a markup language developed by the World Wide Web Consortium (W3C) to organize and deliver content more reliably through the use of customized tags.

### DESCRIPTION OF THE PREFERRED EMBODIMENT

We will now describe the various aspects of our invention.

Invention Overview

Every organization is unique and each company has its own distinctive configuration of hardware, software, databases, enterprise applications, product customizations and network infrastructure. Fixed models for integration don't scale because they fail to address a company's individuality. Our invention treats each monitored application within the integration environment as the center of its own unique universe, continually examining the application (data, business logic, etc.) for changes while accommodating the uniqueness of each application within the integration environment. This approach provides a system that efficiently and dynamically (in terms of time, resources, and event driven actions) analyzes changes to heterogeneous software applications, integration environments and/or data resources that is both platform and application independent and provides a robust application change management control that allows the user to immediately determine the downstream impact of installing product revisions, patches or new versions within his or her integration environment. Its revision control infrastructure can help solve data integration adapter maintenance and support issues, reduce dependencies on integration professional services consulting, enhance data security and decrease the risks associated with software upgrades.

The main aspect of our invention is as an automated interoperability analysis and code generation tool, or intelligent, dynamic universal adaptor, that dynamically detects application changes, analyzes revisions, generates data mapping between heterogeneous applications, performs error validation, and executes necessary adapter modifications. It features a robust software infrastructure for adapter construction, maintenance and support that consistently develops, deploys and monitors Intelligent, Dynamic Adapters. When a monitored application has been modified, the invention uses a proactive planning and learning approach to determine how best to update the application's integration adapters. This significantly reduces the amount of human intervention as well as the risk, cost, time, and manual effort required to update application integration environments.

System Architecture

The system including our invention can be built on a highly extensible, flexible and robust distributed architecture allowing it to scale for an almost unlimited amount of users and enterprise applications. The benefits of this architecture include providing ability for deployment in highly complex IT environments, the ability to distribute processing requirements across the IT environment without affecting other critical IT systems, the ability to support fail over, among other functions.

The distributed architecture can be built on Jini technology from Sun Microsystems, which allows highly distributed components to coexist independent of each other. Jini provides the infrastructure necessary for components to log services and allows other components to find those services when required. Along with Jini, other technologies can be used to further allow flexibility, extensibility and robustness. These technologies include Remote Method Invocation (RMI) for inter-process communication between different components and the use of JavaSpaces as a standard way to persist objects and messages across components. System architectures can be viewed in different ways. Two ways that have been used are Logical Architecture and Physical Architecture.

The Logical Architecture describes the behavior of a system's application. Since the system of the current invention can be written in Java, the descriptions of the logical architecture map directly to Java packages and classes. For the most part, component types can be mapped to Java packages. Components can be mapped to Java classes.

The Physical Architecture shows how the logical architecture is mapped to physical things, such as operating system (OS) processes and machines. Put another way, the components defined in the Logical Architecture are allocated onto OS processes and machines. This provides the perspective of how components map to the real, physical world. Because the system components can exist in multiple OS processes on multiple machines, the system architecture is distributed.

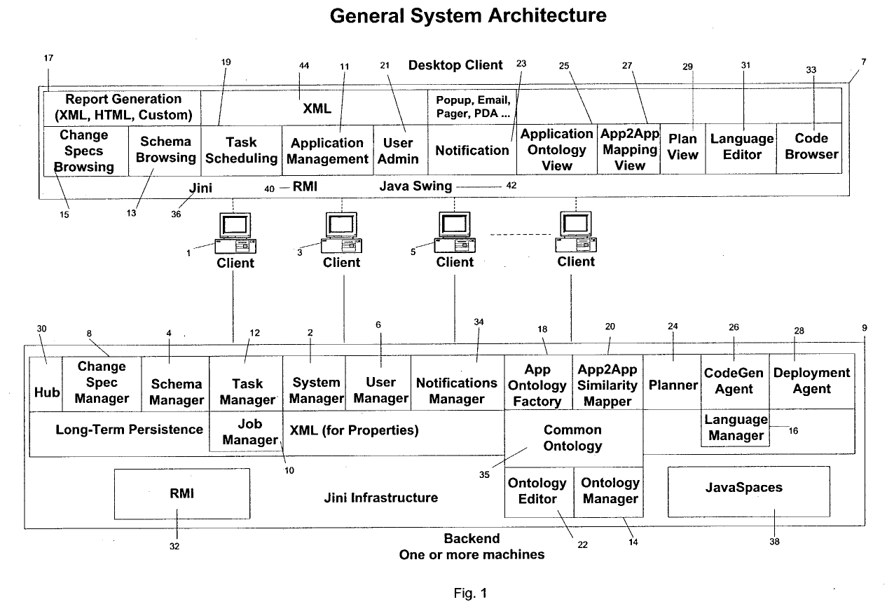

The system architecture is illustrated generally in FIG. 1 showing both logical architecture and physical architecture.

Logical Architecture

A number of major component types of the Logical Architecture can be classified as:

1. Model

2. Managers

3. Factories

4. Agents

5. Desktop Client

6. Hub

7. Notifications

8. Jini and JavaSpaces

9. RMI

10. Exceptions

Each is described below.

The Model

Model components contain data used by other components within the system. When data is exchanged between server and client components, the data is packaged as one or more Model objects. Examples of the Model component types, along with their components, are:

1. Job (Jobid, JobStatus, JobSummary, Step)

2. System (Application, Appld)

3. User (UserData, Userld, User, UserName, UserPassword, UserPreferences)

4. Change Specification

5. Schema

6. Application Ontology

7. App2App Similarity Map

8. Common Ontology

9. Database

System Managers

Backend server components are implemented in the form of managers that address different aspects of the system. The Managers provide the server-side functionality for the system of our invention. Put another way, Managers provide the business behavior and rules for the system. Examples of Managers seen in FIG. 1 are:

1. System Manager 2, which manages system-wide settings and data.

2. Schema Manager 4, which provide, store, list, and delete schemas.

3. User Manager 6, which manages users and their preferences.

4. Change Specification Manager 8, which manages storage and retrieval of change specifications. Each change specification represents the changes between two specific snapshots of a schema.

5. Job Manager 10, which manages jobs that may run for a long time. Typically, jobs perform heavy analysis and automation.

6. Task Manager 12, which manages and runs scheduled tasks.

7. Ontology Manager 14, which maps the access to and modification of the Common Ontology and other application ontologies.

8. Language Manager 16, which manages the different programming languages in which the system can produce integration adaptors, also referred to as dynamic adapters. This managers allows an advanced user to set preferences for the delivery of language-specific adaptors.

System Factories

The system of our invention has several factories running on the server side which produce specific kinds of models. Besides production of models, the factories also have the role of managing persistence operations for the models. These are seen below with reference to FIG. 1.

1. Application Ontology Factory 18, which maps application schemata to the Common Ontology 35 and produces application-specific ontologies.

2. App2App Similarity Mapper 20, which maps a specific application ontology to another application ontology and produces a map of potential integration points between the two applications.

3. Ontology Editor 22, which acts both as a manager and a factory, manages direct human interaction with the Common Ontology 35 for validation, expansion and modification of the Common Ontology. It also provides a visual representation of the Common Ontology 35.

4. Planner 24, which produces an interactive integration plan between two disparate applications based on the App2App Similarity Map.

System Agents

The system implements agents that run on the server side, are highly adaptive and autonomous in nature and interact with internal and external components in a goal-oriented manner. These include:

1. CodeGen Agent 26, which interacts with Planner 24, ChangeSpecification Manager 8 and external application-specific settings such as version and programming language to generate and adapt integration code.

2. Deployment Agent 28, which interacts with external application environment elements and the CodeGen Agent 26 to deploy and validate code in a self-adapting fashion. It is self-adapting to the extent that when a change such as an IP address change occurs, it is detected and the deployment agent makes the necessary modification autonomously or semi-autonomously by further inquiring input from the human operator to insure the continued operation of the code.

Desktop Client

The system Desktop Client is seen in FIG. 1 in logical architecture form 7 and in physical architecture form 9. It is used to provide the graphical user interface (GUI) between users and the system. The Desktop Client runs on users' or clients' desktops. It can make requests of the system server components via system Proxies, receive data from those requests, and present that data to the user. Even though the Desktop Client is a full desktop application, it does not need to provide any business logic.

The Desktop Client contains the following views each functioning as indicated:

1. Application Context, illustrated as Application Manager 11

Lists the applications which were previously defined by the users.

Shows detailed information for the selected application.

Adds, modifies or removes application definitions in response to user requests.

2. Schema Context 13

Lists the previously collected schemas.

Shows detailed information for the selected schema.

Adds or removes schemas in response to system or user requests.

3. Change Specification Context 15

Lists the previously created Change Specifications.

Shows detailed information for the selected change specification.

Add, or remove change specifications in response to system or user requests.

4. Report Generation Context 17

Uses a File selection dialog to open previously saved reports.

Creates a new report from an existing schema or change specification.

Saves the current report to the local disk, in HTML or XML.

5. Task List Context 19

List the pending/scheduled tasks for the current user.

Adds, modifies or remove a task.

6. User Administration Context 21

Lists the users of the system

Sets up new users

Administers passwords

7. Notification Context 23

Displays notifications

Sets up notification preferences

8. Application Ontology View Context 25

Lists Application Ontologies

Displays Application Ontologies for browsing

9. App2App Similarity Mapping Context 27

Lists App2App Similarity Maps

Displays App2App Similarity Maps for browsing and user acceptance

10. Plan View Context 29

Lists integration Plans

Displays Plan for user browsing and acceptance

11. Language Editor 31

Lists language supported

Displays specific language settings for user browsing and preference selection

12. Code Browser Context 33

Displays code in specific language for user browsing, saving and preference settings

A context as used above is a particular view or component of the user interface that the user can use to perform specific tasks, browse through system output or interact with the system in general. Each context has a server side counterpart with which it interacts to produce the desired functionality.

System Hub

The System Hub 30 is a broker, which means that it is used to connect client components with server components. It need not, and usually does not, however, perform the communication between clients and servers. Rather, the Hub provides clients (typically the Desktop Client) with components that can be used to directly communicate with server components using Java RMI (Remote Method Invocation) 32. In system terms, the Hub provides Proxies to clients. These Proxies know how to communicate directly with Managers, which run on the server.

A portion of the Hub runs on both clients and a server. The portion of the Hub running on the server registers itself with Jini as a Jini service. To register in Jini, means that it makes an entry in Jini that other services can look up and connect to if necessary. Once this registration takes place, client Hubs can now find the server Hub. Communication between client Hubs and the server Hub takes places using RMI/JRMP.

A Proxy running on the client finds its associated Manager after the Manager has registered itself as an RMI server object with the server Hub. Once that registration takes place, Proxies can find Managers and they can communicate directly using RMI/JRMP. Manager registration is part of the initialization step for the Hub running on the server.

From the Desktop Client's perspective, communication with Managers to perform the needed processing is straightforward. When the Desktop Client is started, the client Hub is automatically created and initialized. Afterwards, the Desktop Client can ask the client Hub to provide a Proxy. The Desktop Client can then use the Proxy to communicate directly with its associated manager, bypassing the client Hub completely.

System Notifications

Notifications provide events of interest to the system components. For example, a Desktop Client component may want to know when a particular job has been completed. The component would register interest for a “job completion” event for a specific user. Since registration takes place through Jini, other services that have been registered in Jini will be able to read the request and provide the information if available. When the job for that user has completed, a notification is sent to the registered Desktop Client component. Notifications, managed by Notifications Manager 34, provide a way to check on status rather than continuously polling that status. The system uses both push and pull methods of notifications. Notifications can be persistent, or stored, [symbol] rather than transient. This means that a registered component receiving a notification does not have to be online at the time of the notification to receive the event. The component can register interest for a particular notification, disconnect from the system, reconnect at a later time, and receive any outstanding events. Notifications can also be set up to be distributed via email, SMS or any other kind of delivery mechanism.

Jini and JavaSpaces

Jini 36 is an object-oriented, distributed processing infrastructure technology developed by Sun to enable the creation of dynamic distributed processing networks of services. Jini provides a way for servers to register their services (with Jini). Clients can use Jini to obtain access to those services. Services may run completely on either the server or client, or partially on both. Once a client has found a service, Jini is not used to facilitate the communication between clients and servers. Instead, the client and server communicate directly using the protocol defined by the service. Jini does, however, use RMI as its mechanism for servers to register services and clients to find those services.

JavaSpaces 38 is a Jini technology that provides transactionally secure, asynchronous object exchange and object storage for distributed applications. Instead of direct, synchronous communications, JavaSpaces allow applications to communicate indirectly and asynchronously. Using JavaSpaces allows application components to put objects into one or more JavaSpaces. Those objects can be retrieved later by other application components (in the same or different application) using JavaSpaces. JavaSpaces are Jini services, which can have leases so they can come and go on the network.

The system uses Jini services in two places:

1. The Hub, which is a Jini service.

2. Notifications, which use JavaSpaces, which, in turn, are Jini services.

The system uses JavaSpaces in two ways:

1. Asynchronous messaging mechanism to support system notifications.

2. Short-term data storage mechanism (e.g., holds job status for short period of time).

Java RMI

RMI (Remote Method Invocation), shown at 40 in FIG. 1 in respect of desktop clients, is a Java network protocol, which provides the distributed mechanism that allows system Proxies to communicate with Managers. RMI can host two other higher-level transport protocols, JRMP (Java Remote Method Protocol) and IIOP (Internet Inter-ORB Protocol). JRMP is the native, default, and Java-only higher-level protocol. IIOP allows Java objects to communicate with CORBA or J2EE objects. RMI relies on TCP/IP for its underlying network protocol.

RMI is used for communication between system Proxies and Managers, as well as the client and server portions of the Hub. The system currently can use the default RMI/JRMP.

Java Swing

Swing 42 is a technology that is part of standard Java. It provides (along with other complimentary technologies, such as AWT) a framework and list of graphical components for building portable graphical user interfaces. Swing is usually used to build Intranet-based application (i.e., those applications that exist behind company firewalls). Typically, Swing is not used for Internet-based applications.

XML

XML 44 is used to represent the following kinds of data:

1. Schemas on the Desktop Client. DOM XML technology is used.

2. Change Specifications on the Desktop Client (only written at this time). DOM XML technology is used.

3. Reports on the Desktop Client. These reports can be transformed using a report template (XSLT) into an HTML file, which can be viewed later by the user.

4. Properties on the Desktop Client (manually written, automatically read)

5. Properties on the Server (manually written, automatically read)

### DETAILED DESCRIPTION OF INVENTION COMPONENTS

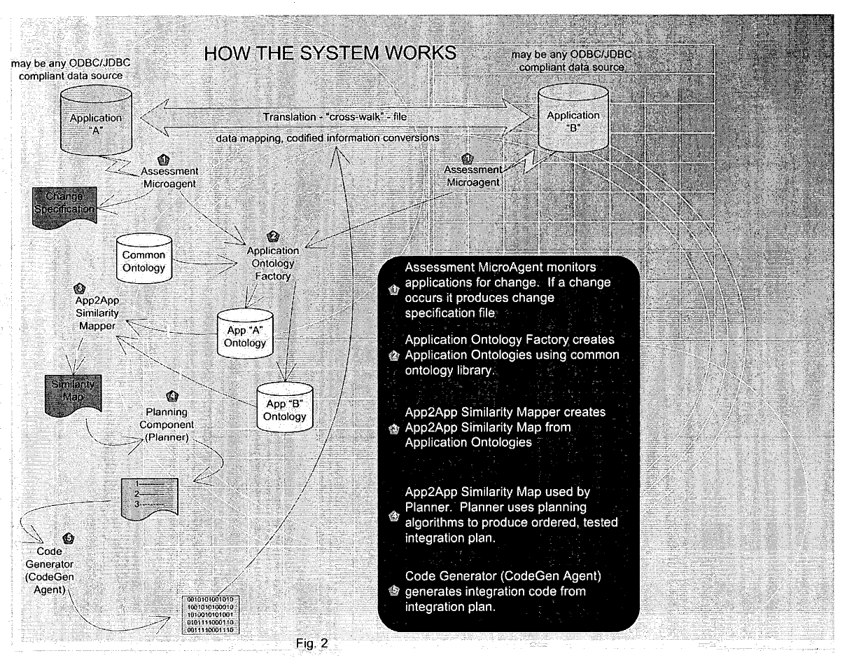

The invention is illustrated in an alternate illustration in FIG. 2 and includes processes associated with Assessment Micro Agent, App2App Similarity Mapper, Planner, Hub, Error Validation and Code Generation components. Note that some of the components in FIG. 1 are in fact subcomponents of the functional components described hereafter. For instance, the Assessment Micro Agent component is composed of the Schema, Change Specification, Task and Job Managers in FIG. 1. In other words, the combination of these managers are an embodiment of the Assessment Micro Agent.

The functional components of the invention are described in FIG. 2. This figure shows how the functional components interact with each other and with two applications that are the target for integration.

First of all, applications A and B, which may be any ODBC or JDBC compliant data sources, are monitored by the Assessment Micro Agent component of the invention. Note that ODBC and JDBC are just examples of data source standards, but the Assessment Micro Agent might support other standards as well such as XML, HL7 or any other standard available that provides data structure information. The Assessment Micro Agent, when first installed, creates a complete inventory of the data structure and functionality of the data source and makes it available to other components of the invention as described below. If a change occurs in either of the applications the Assessment Micro Agent interacts notifies other components of the invention that then act upon this information as described below.

Once the Assessment Micro Agent has been installed in two or more applications, it is possible to produce similarity maps between those applications based on the data structure inventory provided by it. In order to accomplish this, the Application Ontology Factory uses application data structure information provided by the Assessment Micro Agent and the information provided in the Common Ontology library to produce the application ontologies. Then the App2App Similarity Mapper then uses the information in the application ontologies to produce a similarity map between the applications. Once the similarity map is completed, the Planner uses the information contained in the similarity map to produce an integration plan. Then the CodeGen Agent uses the information provided in the integration plan to produce the integration code. After the integration code is validated by the Error Management Micro Agent, the it is deployed as the x-walk file between the applications and thus they become integrated.

The details for the process of each of these components are described in more detail in the following sections.

Assessment Micro Agent

The Assessment Micro Agent serves three primary functions: schema discovery, change monitoring and system or user notification of changes.

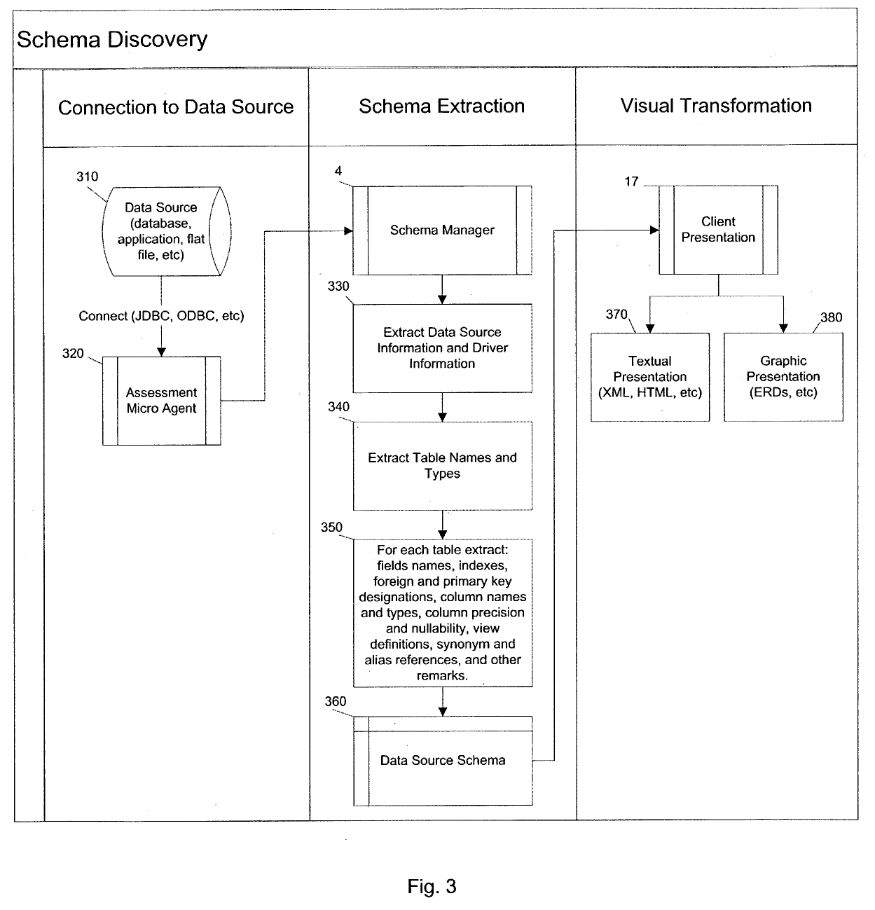

FIG. 3 illustrates the process of schema discovery. The first time the Assessment Micro Agent 320 is installed for a given application 310, schema discovery is initiated. Schema discovery involves reading the meta-data stored in a data source 310 to produce a schema 360 that is placed into a memory model, which can then be displayed in textual 380 or graphic 390 form. This process is carried out by the Schema Manager 4 of FIG. 1. and includes collecting the following: data source information, data source driver information, table names, table types, indexes, foreign keys, column names, column data types, column precision, column nullability, primary key designation, view definitions, synonym and alias references, and remarks stored in the database schema as illustrated by 330, 340 and 350. The collected information can then be displayed by the client 17 of FIG. 1 in either a textual presentation 380 or graphic presentation 390. The schema 360 extracted in this manner becomes the input for ontology generation.

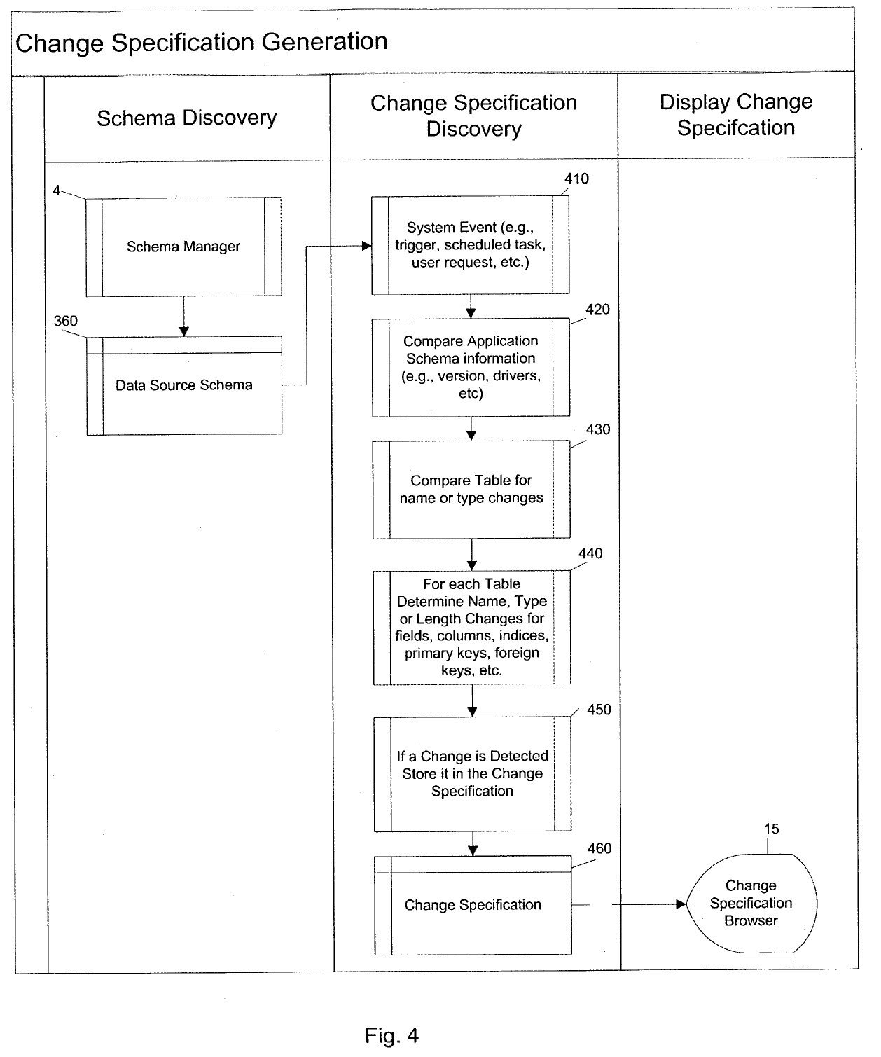

The invention's change monitoring capability provides detailed analysis through the Change Specification Manager 8 of software under consideration so that the user knows exactly what is different between product versions. The Change Specification Manager receives input of schemas from the Schema Manager 4. The Change Specification Manager 8 then creates change specifications if something has change between versions of the schema. It can manage revision control against new versions, patches and application upgrades that may affect data interoperability and in turn makes possible the development, maintenance and support of intelligent, dynamic adapters that contain application-level business logic, dependencies and constraints at the sub-modular level. Using an event driven model that is triggered by a system change, the Change Specification Manager 8 automatically detects alterations in the database structure of an application by making comparisons of schemas generated by the Schema Manager 4. When an application is being monitored, the Change Specification Manager 8 proceeds to analyze the change by comparing the new schema to a previous schema or schemas. First the Change Specification Manager 8 is triggered by a user or a system event 410. As seen in FIG. 4, the Change Specification Manager, described subsequently, compares schema information 420 for one historical view of the schema of one application to another historical view of the same application. The trigger mechanism 410 can be set as a scheduled task in the task manager or by some application dependent event such as a trigger mechanism, which usually is included in most commercial database management systems. The comparisons are done first at the table level for name or type differences 430. Then for each table the Change Specification Manager 8 compares meta-data information 440 such as name and type and length changes for the fields, columns, indices, primary keys, foreign keys, etc. The changes are then stored in as a change specification 450 for use by other components of the invention. If required to do so, the Change Specification Manager can show the change specification to the user via the Change Specification Browser 15.

The Assessment Micro Agent resides on an application server. The Assessment Micro Agent is application/product/version agnostic, which means that because its focus is exclusive on data structures, it does not depend on particular implementations of applications, products or versions of those applications of products.

In our implementation of the Assessment Micro Agent, we have further broken it down to at least four more components that provide distinctively useful functionality. These include:

Schema Manager. This component connects to applications through standard interfaces, which include JDBC, ODBC, Flat File Translators, and the like. It makes an analysis of the application and extracts the meta-data model in the form of a schema. The schema manager stores the schema and then provides an interface to other components to retrieve the schema when necessary. For instance, the Change Specification Manager retrieves schemas to produce change specifications on the schemas. The schema manager also allows the schemas to be exported into other formats, including XML, Serialized Java Objects, HTML and others.

Change Specification Manager. This component performs a complete analysis of what is different between two different versions of an application by comparing the schemas associated with each version. It presents the change specification file to the user in a structured manner with specific information as to what changed in the schemas, when and how. As it is the case with the schema manager, it also allows the change specification files to be exported in other formats.

Task scheduler. This component allows the user to schedule tasks in an event-driven or user defined manner. The tasks include the generation of schemas through the Schema Manager and the generation of change specifications through the Change Specification Manager.

Notification Manager. This component provides an interface in which users can define notifications at several levels of granularity. This includes setting up notifications on the complete file of the change specifications or on filtered views of the files according to the user preferences. The Notification Manager can send notifications via standard mediums such as email, pager or PDAs according to the user preferences.

Although, these components perform some of the most important tasks of the Assessment Micro Agent, these components do not provide all the functionality of the Assessment Micro Agent, as it also performs other processes that provide useful functionality independently of these components. These processes include the ability to monitor connectivity to the applications, the ability to orchestrate the schema monitoring, change specification retrieval and send system-level notifications and user alerts. An additional functionality that is allowed by the Assessment Micro Agent is the ability to allow user to create filtered views of changes according to their preferences.

Application Ontology Factory

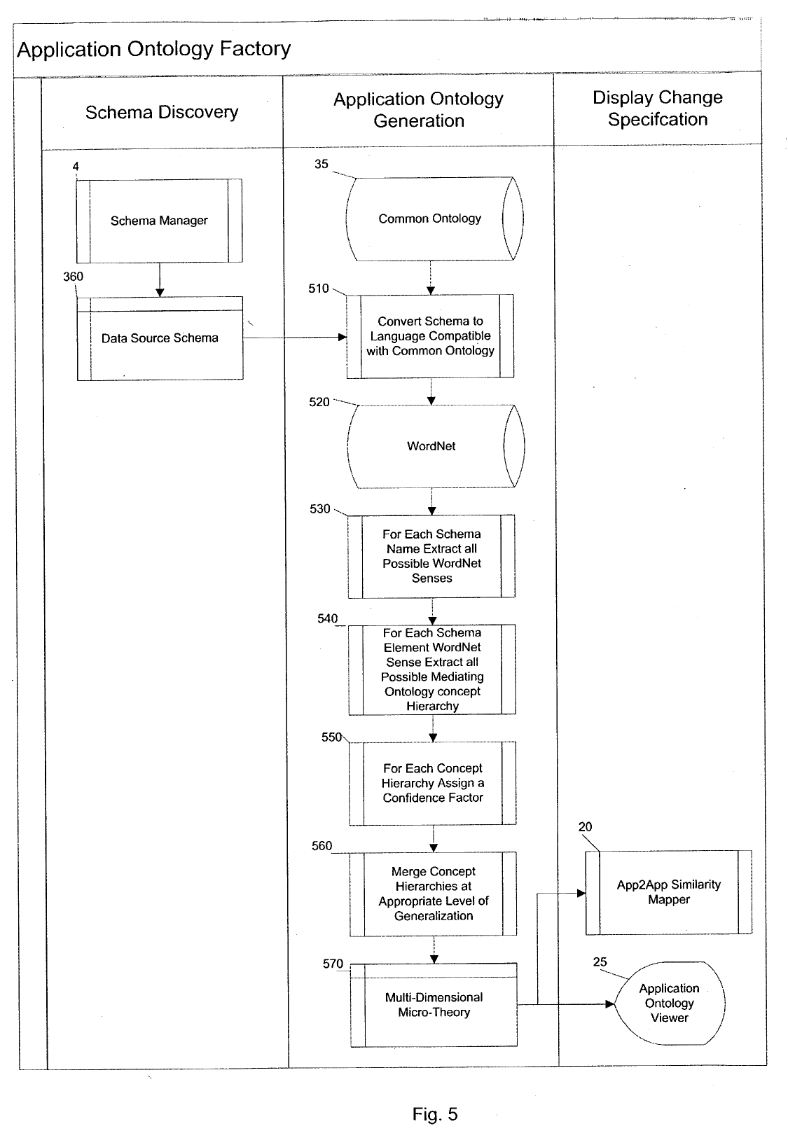

The Application Ontology Factory 18 converts the schema obtained from the Schema Manager 4 component of the Assessment Micro Agent into a language compatible to the mediating representation or common ontology 510. In a sense, this is like describing a schema utilizing the syntax of the common ontology language. After this conversion, each schema element identifier is mapped to the WordNet 520 to extract all or substantially all possible senses of the element 530. These senses are then utilized to extract all possible mediating ontology concept hierarchies to which the element might be a top-most specialization 540. Each concept hierarchy is then assigned a confidence factor 550. It is important to notice that a schema element might be associated with one or more concept hierarchies because of its possible multiple senses, but each concept hierarchy will have an independent confidence factor. The collection of concept hierarchies is then merged at the appropriate level of generalization 560 producing what we refer to as a multi-dimensional micro-theory 570. A micro-theory, because it captures concepts associated only with a particular schema. Multi-dimensional, because a schema element might be associated with one or more concept hierarchies. We refer to a micro-theory as the application ontology as it is replicated and maintained separately from the common ontology. The application ontology is made available to the App2App Similarity Mapper 20 or to the Application Ontology Viewer 25 if required by the user. These steps are illustrated in FIG. 5.

App2App Similarity Mapper

Generating data mapping between heterogeneous applications is the result of the App2App Similarity Mapper, described hereafter.

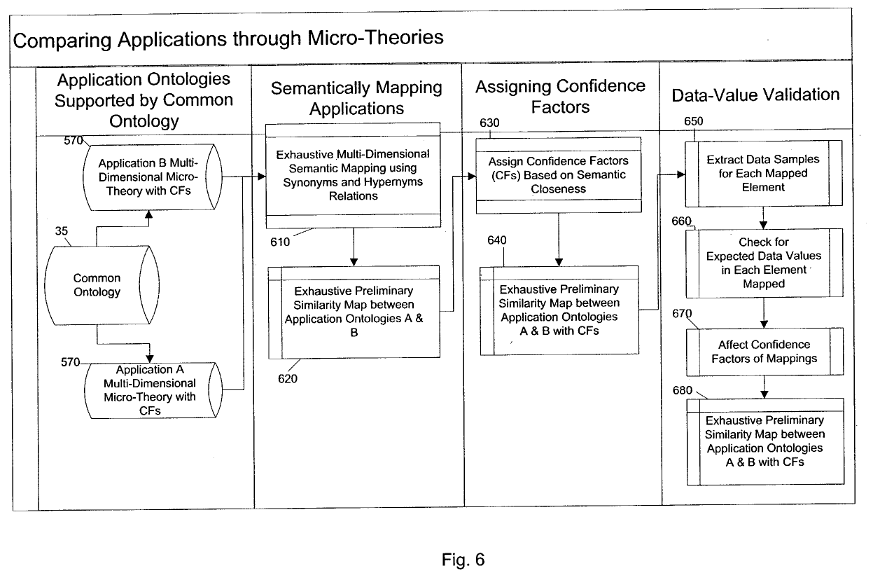

The system of our invention uses advanced pattern matching and planning algorithms to learn how changes are handled for each unique organization and then deals with those specific configurations. The invention is capable of analyzing alternative data mapping strategies with or without human intervention by utilizing intelligent computer programs that analyze and react to changes. A change in a monitored application is viewed by the invention as a problem that can be solved by analyzing the exact nature of the change, evaluating alternative data mapping possibilities, and by adjusting the existing adapter integration code structures to address the new variables. There are a number of strategies to do data mapping. Most importantly, all multi-dimensional aspects of each micro-theory produced by the Application Ontology Factory 18 are exhausted to produce a list of possible mappings 690 between the micro-theories. Mappings 690 in the list might consist of one to one, one to many or many to many element mappings. Each mapping has an associated confidence factor 695, which reflects the probability of the mapping being accurate. To map two micro-theories we first utilize the senses of each schema element 430 and search for synonyms and hypernyms 610 in the WordNet 420 to produce an exhaustive similarity map between the applications 620 and assign confidence factors 630. This process is illustrated in FIG. 6. The result is an exhaustive preliminary similarity map between the applications with an assigned confidence factor for each mapping 640. Then the system extracts samples of the data for each mapped applications 650 and check for expected data values of mapped elements 660 to affect the confidence factors positively or negatively depending on the closeness of data 670. The result is a similarity map between the applications with refined confidence factors 680.

In addition, we also systematically apply a series of structural comparison techniques to further refine confidence factors and identify other potential mappings not possibly found through synonym and hypernym relations or expected data values. These structural comparison techniques are particularly useful to find mappings for concepts that have been given arbitrary denominations with no easily identifiable meanings. Some of the pattern matching algorithms used are well known in the computer science and artificial intelligence community. These include Naive Bayesian Classifiers, Neural Networks, Induction Algorithms, and the like. First, an application to ontology mapping is generated for each application being mapped. The invention utilizes a powerful pattern matching approach to application to ontology mapping, which is based on evaluating the mathematical probabilities of lexical and semantic relationships between schema entities and ontology concepts.

Lexical closeness is first determined between the application ontology and global ontology concepts, in fact producing synonym relationships. The approach goes one step further to determine mathematical closeness of semantic relationships in the form of hypernyms. A hypernym is a hierarchical relationship between semantically similar concepts which have a common parent somewhere in the hierarchy. For instance, a dog and a fox are semantically similar in that they both belong to the canine family. However, although a cat and a dog are both carnivorous mammals, and thus are semantically similar, the semantic closeness between a dog and a cat is not as strong as between dog and a fox. This way we are able to discover both synonym and hypernym relationships and attaches confidence factors based on the mathematical probability of being lexically and semantically close respectively.

The next step is to compare the application ontologies of the source and target applications to determine common concepts. This is a multi-tiered approach which involves several independent approaches as follows:

Map source and target application ontology elements using synonym and hypernym relationships.

Validate expected data values for source and target application ontology mappings.

Compose and decompose semantic relationships between target and source application ontology elements.

Unite semantically similar schema elements into new ontology concepts.

Mapping source and target application ontologies using synonym and hypernym relationships: The mapping of source and target application ontologies using synonym and hypernyms is a straight forward process because both application ontologies share the same Global Ontology as their mediating representation. The mapping occurs by determining the combined mathematical closeness of common synonyms and hypernyms.

Validating mappings using expected data values: When source and target application ontology elements are found to be mathematically close to each other, we go one step further to validate the closeness using a unique approach that performs pattern matching on the data values of both source and target elements. The pattern matching mechanism works by looking at how close data values for the source and target elements are. We use pattern-matching methodology that normalizes data properties such as type and length and looks at the values themselves. This approach is very powerful because it allows us to map data structure components that might be similarly lexically or semantically, but might have different data types. For instance, a source application might have a data structure element called Phone while the target application might have one called Telephone, which map lexically and semantically. However, Phone might have a string data type and Telephone an integer data type. The invention's pattern matching mechanism will be able to determine data value closeness regardless of this kind of data property differences.

Composing semantic relationships: In some cases, there are application data structure elements that have designations not easily associated to other elements through synonyms or hypernyms. For instance, some systems use machine-generated labels that combine letters and digits to produce an element name such as XYZ123. With our approach it is still possible to determine the semantic similarity by comparing data values and then deriving semantic similarity based on semantic proximity of other items related to XYZ123. For instance, assume XYZ123 is a schema element for an application (the source), which we want to map to another application (the target). Assume further that XYZ 123 has a functional relationship with items X1, Y2 and Z3. Furthermore, let's say that X1's data value contains street names, Y2 contains city names and Z3 contains zip codes. Now, let's suppose that there is another schema element on the target application called address, which has a functional relationship with other schema elements called street-number, street-name, city-name, state-name and zip-code. Using an approach, which determines that the values of X1 and street-name are similar, Y2 and city-names are similar and that Z3 and zip-codes are similar, we can now infer that XYZ123 and address are really similar. This is called composition in our approach, because we composed the relationships between X1 and street-name, Y2 and city-name, and Z3 and zip-code to infer that XYZ123 is similar to address.

Decomposing semantic relationships: Decomposition works almost the opposite of composition. Let's suppose that the source application has an element called Add and the target application had another element called Address. Using the lexical proximity we can discover that add and address are similar. However, Add has a non-functional relationship with a string value, while Address has a functional relationship with other schema elements called Street-number, Street-name, City-name, State-name and Zip-code. A non-functional relationship in this case could mean that Add is a schema element with a value, while a functional relationship means that Address is associated with the other schema elements through primary keys. Because we have already established that Add and Address are lexically similar, but structurally different, we explore further whether the data values of Add and Address display any similarity. Therefore, we apply our induction algorithm between the data values of Add, Street-number, Street-name, City-name, State-name and Zip-code. Let's suppose that the value of Add contains strings with values such as “123 Main St. Sacramento, Calif. 95123,” 4567890 El Camino Real Road Apt 30, Mountain View, Calif. 94123” and “1234 Central Boulevard, Carson City, Nev. 95321.” Using the target schema elements in conjunction with an induction algorithm, we can associate Street-number, Street-name, City-name, State-name and Zip-code with portions of the value of Add. In fact, the induction algorithm generates rules that can then be stored with the source application's micro theory in the form of axioms that logically decompose Add into elements that can be mapped to Street-number, Street-name, City-name, State-name and Zip-code on the target application. The obvious question would be “why not just generate general rules that can be used in general for all situations like this?” The answer is that in most cases the axioms generated are particular to the way two specific application micro theories map. For instance, in this example the target application's Street-name element contains the name of the street (e.g., “Main St.,” “El Camino Real Rd,” “Van Ness Boulevard,” etc ) and the unit number (e.g., “#100,” “Apt. 200,” “Suite 123,” etc). Other application schemas might make explicit separations of these elements by further dividing Street-name into Street-name and Unit-number, therefore requiring a different set of rules, which our induction algorithm generates automatically.

Uniting schema elements to form a new concept in the ontology: It is also possible to learn from mappings between schema elements of two disparate applications to form new concepts in the ontology. This happens when two or more schema elements from an application can be mapped to one element in another application. Assume that we have a source application which has two schema elements called home-address and mail-address. If the target application has a schema element called address, which has been mapped to a concept in the ontology called address, then using the techniques described above will result in both home-address and mail-address being mapped to address in the target application and subsequently the ontology concept of address. If address is the last concept of a hierarchy in the ontology and has no children concept, we can now propose that home-address and mail-address be added to the ontology.

When a mapping is established for the first time among schema elements, we assign an initial value according to what pattern matching mechanism was used to arrive at the mapping. Furthermore, every time a mapping is accomplished by lexical, semantic, expected data value, composition or decomposition, we increase the confidence factor. Every time a mapping is refuted by any of these pattern matching mechanisms, especially the expected data value comparison mechanism, then we lower the confidence factor. For instance, lexical similarity will have a lower confidence factor than lexical plus semantic mapping, semantic mapping will have less confidence factor than semantic and expected data value and so forth.

Planner

The Planner, which was originally known as the Modification Planner Micro Agent, like the Assessment Micro Agent, is an intelligent software component separate from the application specific knowledge base that defines the operations to be planned and executed. The Planner receives the change specification file created by the Change Specification Manager component of the Assessment Micro Agent and uses a proactive planning and learning approach to develop and logically test an ordered adapter development plan.

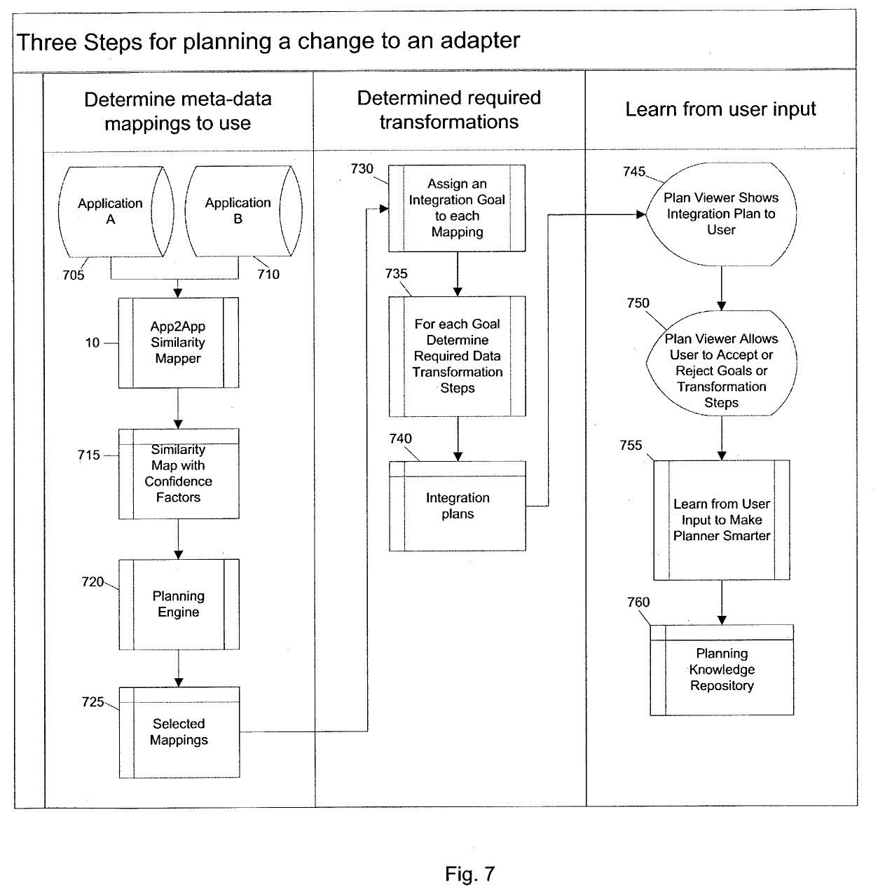

As illustrated in FIG. 7 there are three main steps that go into planning an integration adapter. First, the planner 24 determines which meta-data mappings between applications to use through a planning engine 720 that evalutes the confidence factors previously determined by the App2App Similarity Mapper 10 between each monitored application (e.g., 705 and 710). The App2App Similarity Mapper 10 produces a similarity map with confidence factors 715 that have values ranging from 0% to 100%, which identify degree of comfort about the accuracy of the data mapping. The planning engine 720 produces a list of selected mappings 725 with high confidence factors that will be the basis for defining the steps to create interoperability between schema elements. If the confidence factors are low, then the planner presents alternative steps that reflect the mappings with lower confidence factors.

The second step for the planner is to assign a goal 730 to each mapping and then determine required data transformation steps 735 that need to occur in order for the goal to be completed to produce an integration map 740. These tasks are accomplished using a synectics-based skeletal planning approach to compose multiple courses of action specific to the monitored software application's ontology model, which results in detailed plans for maintaining and supporting integration adapters. These plans will be used by the Script Generator to develop new integration adapters.

The third step for the planner is to show the resulting plan 745 to the user for his approval or rejection 750 and to learn from user evaluations of the plan 755. Whenever an end user edits a data mapping plan, the invention uses the information as input into the system's planning knowledge repository 760 allowing the system to learn and prepare for future modifications.

When the Assessment Micro Agent determines that an application's data structure has changed, it informs the Planner to generate a new plan if the previously generated plan has been affected by the changes. The following describes the flow of events for when an application changes and the invention has already generated an integration plan between that application and another. When a change has been detected the system attempts to automatically produce a new integration plan that will serve as the basis to modify the existing adapter. The first thing that happens is that the system creates a Change Specification File that describes the changes that occurred at the application's data structure level. Once this Change Specification File is available, then the system goes through a discovery process, which determines which components of the adapter have been affected. Next, the system maps the affected schema elements into the existing application ontology. Then it performs lexical and semantic mapping on the affected elements to find new associations with the target application ontology. If it finds any, it then tries to validate them using data value validation as explained before in this document. After the validation is done, or in parallel with this validation, the system attempts to find new mappings for the affected elements using the expected data values approach. If mappings have not been found yet, it attempts to find new mappings using other approaches describe above, such as composition and decomposition. Finally, it produces the new map and presents to the user. If the user accepts the new mappings, then the mappings are handed off to the planner, which generates the new plan with its associated confidence factors as obtained during the mapping process.

CodeGen Agent

The CodeGen Agent takes the approved ordered integration plan as input and executes the development of new adapters converting the steps in the plan into a user selected programming language. Reparsing deals with taking a source code in one language and translating that code into another language. Pseudo code generated by the code generator can be used, translating it into a target language. Commercially available reparsing software can be used for doing this. This is accomplished using an XSL style sheet that contains transform tags that translate each integration operation (get resultset, truncate, round, concat, and others) into compilation-ready source code for the selected adapter language. In the case of object-oriented languages, packages or libraries with the functionality for each integration operation are included with the product. In the case of a procedural language, the Scripting Agent reparses the plan into procedural code of ordered operations. Examples of code generation include languages including SQL, Java, C++, XML, x.12 or any of a number of other popular integration programming languages. The libraries are commercially available libraries. It will work by translating the pseudo code generated by the code generator into a language of choice of the user. In the case of object-oriented programming languages, it is common to describe classes, objects, methods and other object oriented constructs. Because most object oriented languages are similar, the translation from one language to another if fairly straightforward. In the case of pseudo code, it is even more so, because generated pseudo code is very general in nature.

Error Management Micro Agent

The Error Management Micro Agent takes expected and actual output from the Planner and the CodeGen to determine and categorizes program errors and remediation plans. The Error Management Agent is capable of detecting errors in code generation (that is, syntactic correctness of the generated code, through using compiler and script verification technology), data extraction, aggregation and insertion. Data extraction, aggregation and insertion refers to the logical correctness of the generated code. This can be done by a) use of a database emulator and b) comparing the results of the emulations against the desired goals as identified by the planner. This is for the “local” results of a change. For the system impacts, a system graph of the interactions will be created with analysis of cyclic dependencies that are impacted by a change. For all applications in the system impacted by the changed elements, the database emulator for each impacted application will be used to evaluate the correctness of the change. System inconsistencies will be reported or if all system dependencies are satisfied, the planned code will be marked as validated.

This agent also works in concert with other system components to detect user input errors (incorrect execution) by checking inputs against valid single values, valid ranges of values, and discrete lists of values (so-called picklists) to ensure that the value entered by the user will not jeopardize the integrity of the system.

This Agent also detects user intent errors (mistakes, correct execution of the wrong task) and breakdowns in coordination across multiple users.

Detecting user intent errors includes (a) enforcing constraints on critical system actions (for example, a user will not be able to deploy an integration plan that was created based on a change specification that was generated from a “pseudo” schema—one the user edited; this is an example of execution with the wrong type of data); (b) checking models of common usages of the system before execution of critical operations to flag actions and issue warnings on requests for these critical actions that do not fall within the constraints of the system or fall outside the models of normal, expected usage. Critical operations are considered those that have the potential for corrupting application data or producing flawed results from the targeted applications. For example, creating and deleting the same logical change specification 10 times within 10 minutes is not a normal usage, but wouldn't be flagged since it doesn't fall within the definition of a “critical” operation since it has no impact on the target application itself. Deploying code that has not been validated would be a critical operation that deviates from the expected norm. A warning would be issued to the user and, if so configured, to other users who are registered to be informed of that event by the escalation system. The action would not be completed unless the warning was overridden in accordance with the “workflow” configuration defined by the client (e.g. concurrence with the action from the user and any other designated stakeholder who is on the escalation list for such actions).

Breakdowns in coordination across multiple users are recognized by the system and handled via a workflow model. Two examples of breakdowns of coordination include a lack of an expected action by a user and a conflict between two users. An example of the first case is when the lack of response from User A impacts the intents of User B to perform his job adequately. For example, a system could be set up that requires approval from User A before User B can proceed with the deployment of an integration scenario built by the system. The workflow engine will detect the expiration of time for the approval and escalate the action appropriately. This will be integrated with the constraints in applying the integration plan to allow override in accordance with the configurable, defined corporate policies for the workflow. An example of the second case is where two users make conflicting changes to an integration plan. When the conflict is recognized, it is passed for resolution to the configurable workflow process. The process could be configured to alert the two users. If in a given amount of time the users did not resolve the conflict, the workflow process could be configured to escalate the problem to a designated arbitrator in the corporation.

In addition, putative errors are analyzed for severity of consequences as they pertain to the integration environment. Errors are corrected and these corrections become input to the system's knowledge repository so to allow the system to learn and prepare for future modifications.

The Hub Micro Agent

The Hub Micro Agent is a sophisticated real-time intent interpreter that allows a monitored database to understand and respond to the instructions submitted by its administrators. As the “nerve center” for the system, the Hub Micro Agent directs the Assessment, Modification Planner, Script Executor and Error Management micro agent components to be responsive to the plans and goals of the human users. To implement a change to an integration adapter the user's End User Integration Project Manager uses the Hub to schedule product upgrades, review changes to the user's applications, approve integration mapping plans, and test and execute adapter development plans.

Summary of Process Flow of Invention

In summary, the following are the basic steps taken by the invention with regard to the dynamic maintenance and development of interoperability between systems.

Software application program A (contains business processes supported by some form of data) generates a transaction file describing transaction attributes and data elements for a specific business activity (i.e. business process). The transaction file contains the address of the target business system and the identification of the sending (source) business system and provides both data and interoperability instructions for Software application program B.

The system of our invention, which may be on a CD Rom or downloaded from the Internet, or other apparatus or software components, is installed in the integrated environment. The invention is composed of a set of intelligent software programs that work in concert to automate data collection and decision-making tasks and reduce manpower requirements associated with systems integration by use of realistic, simulations to control the behavior of application interfaces within an integration framework.

The invention analyzes the current integration state and creates a series of comparative knowledge bases appropriate to monitor the integration environment.

The system based on the invention lies dormant unless a change occurs to an application within the integration environment. The invention views a change in the integration environment as a problem that can be solved by analyzing the delta, retrieving the solution to a similar problem and identifies plans that will adjust the interface code for the current situation.

Once the plans are formulated the system can (but is not required) interact with a human to validate the planning assumptions and enables the invention to generate new interoperability code. The human user can elect at this time to abort the creation of new integration linkages. In the event of an abort the comparative knowledgebase is updated with the new attribute information.

If no abort has been called the invention evaluates information from a comparative knowledgebase to identify the correct code structure specific to the interoperability state required by the integration environment and executes multiple simultaneous scripts, setting unbound variables according to the context that exists at the moment of execution so as to dynamically generate new integration code between hosted applications according the plans identified by the invention.

The Error Management Micro Agent evaluates the newly created Transaction File code (a.k.a., cross-walk file) to detect errors in code generation, data extraction, aggregation and insertion or would hinder the software application programs to interoperate (process a transaction and exchange data). Error messages are returned to both the Assessment Micro Agent as well as to a human systems administrator via a graphic user interface. In the event of an error the Planner develops a new plan and the process of compiling new integration code begins again. Once all errors have been eliminated and the integration environment has been stabilized the invention again becomes a passive observer waiting to see a systems change.

Another Embodiment of the Invention

One aspect of the invention can be considered to be a dynamic analysis and revision management tool that can reduce the overall cost and effort understanding the downstream impact of change on enterprise software applications or data sources.

Types of Revision Management Solutions

There are several kinds of revision management systems. The following list describes some of the most important.

Source Code Control Systems.

This type of system is very common in software development environments. These systems allow software developers to work simultaneously on a common code base without the danger of overwriting, deleting or otherwise affecting each other's work. They keep track of who made modifications to the source code and when, and can back out unintended or erroneous changes to the code, as well as keep track of different versions of the code. Examples of this type of systems include Rational Software's ClearCase, Microsoft's SourceSafe, Serena Software or the popular open source CVS system.

Content Management Systems.

This type of system focuses on the management of content, primarily for web-based applications and portals. In most cases, Content Management systems enforce policies for changing and updating content and for establishing connections with content sources. They may also provide specialized search engines or equivalent functionality. Some of these include Vignette, Documentum, Broadvision and Serena Software.

Document Management Systems.

Documentum, FileNet, OpenText and other companies offer document management systems that allow dispersed groups of people to collaborate, synchronously and asynchronously, in the creation and modification of documents. Some of these systems also deal with the digitization of legacy documents, archiving of large amounts of documents and converting between multiple formats.

Application Revision Management Systems.

These systems discover data source changes between different versions of an application and determine the downstream impact of those changes. This can be referred to as application revision management and is generally regarded as the least understood type of revision management primarily because it is mostly a manual process. However, it plays an important role in the enterprise as it deals with changes at the data structure and meta-data levels that may have a profound effect on mission-critical applications and on the business itself. Without some kind of revision management tool data source changes may go unnoticed until it is too late.

Previously, the closest thing to a true application revision management system were the tools embedded in Database Management Systems (DBMS). In addition to the data storage, DBMS store information associated with the application. DBMS usually provide tools to manage revisions of the data structures. However, DBMS generally pays little attention to how changes to those data structures might affect the applications they support and its downstream users. Another aspect of our invention is a novel example of a robust application revision management system. In addition to discovering changes between software and database revisions and helping to quickly determine the downstream impact of those changes, this aspect of our invention continuously monitors data sources, automatically notifies affected parties of any significant changes and keeps historical logs of all changes.

Required of an Application Revision Management Systems

A robust revision management solution should provide the following functionality,

Discover changes.

Help determine when a change or revision to an application might have a downstream impact on its users, whether it is a business manager whose ad hoc report might be affected by the change, or another application that depends on the data being changed.

Assess the above impacts.

Help to quickly and easily determine the impact of application and database upgrades, revision and customizations on downstream users and applications. The system should provide detailed information about each change, but avoid overwhelming users by providing filtered views and other tools to (1) quickly focus on significant changes, (2) assess their impact, and to (3) easily identify users and applications that will be affected by them.

Be capable of continuously monitoring data sources for changes. Changes to data sources can be introduced at any time, not just during version upgrades and other planned revisions. For example, enterprises customize off-the-shelf applications all the time, as required by their business needs. Continuous monitoring assures that all changes to a data source are captured as they happen.

Automatically notifying affected users. These automatic notifications should be targeted for types of users affected. For example, a Systems Administrator will likely require substantially more detailed technical information than a Controller will. Moreover, a Controller will be interested only in changes that affect his applications, whereas an Administrator will likely be interested in all changes.

Keep a detailed historic record of changes so that application owners can make mission-critical decisions on what changes to roll back if that becomes necessary.

Other characteristics of application revision management systems are,

Being substantially non-invasive by delivering value without requiring significant changes to their target applications of their data sources.

Monitoring multiple applications in heterogeneous IT environments using multiple OS, DBMS and hardware platforms through standard interfaces.

The System's Approach to Application Revision Management

This embodiment of our invention reduces human intervention required for data structure analysis by automatically analyzing the impact of new revisions, patches and product modifications on the data structure layer. This information is critical to understanding and minimizing negative, downstream impact. This embodiment of our invention further provides accurate data hierarchies for drill-down data-structure analysis and maximizes productivity by reducing gigabytes of manually collected revision information to manageable reports and feedback alerts. It provides a centralized administration console with an intuitive user interface and minimal click-through navigation, while making available audit functions that allow a user to view previous revisions of the data source and roll back changes if needed.

The invention notifies individuals or groups of users of selected events via email, pager or mobile phone.

The invention serves three primary functions: data source analysis, impact assessment and data asset inventory.

Data Source Analysis.

The invention analyzes a data source and creates a baseline documentation of its data structure. The process can be sequential and can include the steps of:

1. Connecting to the data source through a standard connection such as a JDBC or ODBC connection.

2. Issues standard commands to extract information about the application.

3. Issues standard commands to extract meta-data elements in the form of a schema.

4. Generates structured schema.

This involves collecting data source information, connectivity driver information, table names and types, indexes, primary keys, foreign keys, column names and types, column precision, view definitions, synonym and alias references, and remarks stored in the database schema. Based on this information, the invention then builds an internal model and computes a schema from it. As illustrated in FIG. 3, the schema, the internal model and the meta-data represent the baseline for future change discovery and analysis.

Impact Assessment.

The invention helps improve the decision-making capabilities of IT managers, application developers and non-technical business analysts through a graphic display of real-time information about product change and its impact on an organization. It eliminates the mysteries of what is occurring internally to a product by expediting access, intuitively and interactively, to critical information concerning the physical structure of a data source. This embodiment of the invention dynamically documents a user's selected data sources inclusive of product customizations. This baseline documentation enables an organization to implement true thin-client architecture with access to both real-time and historical models so that the user can monitor how a data source evolves over time.

The invention's Change Specification reports allow the user to quickly assess the impact of change across an application and the organization. This embodiment of the invention allows users to create filtered Impact Analysis Reports and customized views using point-and-click palettes. The process for doing this can be sequential in nature, including the steps of.

1. Connecting to the data source through a standard connection such as a JDBC or ODBC connection.

2. Issuing standard commands to extract information about the application.

3. Issuing standard commands to extract meta-data elements in the form of a schema.

4. Generating structured schema. Displaying schema to user with each schema element containing a selectable check mark as to allow user to make it part of a filtered view.

5. User selecting schema elements of interests and creates filtered view.

6. User going to task manager and scheduling frequency for generating change specification. 7. When the task runs and the change specification manager identifies a change in any of the selected schema elements, it informs the user.

These customized views result in the creation of a personalized visual dashboard that provides immediate “at-a-glance” insight on data source change. Using these Impact Analysis Views, users can generate powerful and highly focused Change Specification reports detailing how specific changes to monitored data sources will impact existing management reports, ad hoc reports and integration adapters, etc. When the Impact Analysis feature is enabled, the invention continually and automatically cross-references identified data source changes to the registered view. When a match is identified, the invention generates an automatic notification with the details of the change. This allows users to spend less time gathering information about the impact of a change and more time managing the solution.

Data Asset Inventory

In addition to the above two primary functions, this embodiment of the invention provides the user with a complete inventory of information related to applications it needs to monitor. Identifying applications for monitoring is a manual process and involves that the user types application names, server name, location, user names, passwords, etc. Once the user has manually identified the applications of interest they are displayed in the list and an inventory of each application capabilities is extracted as explained above in respect of the process for creating a baseline documentation of data structure. This information includes driver type, types of data it handles, types of schemas, features, SQL versions, transaction types, etc. All of this information is made readily available to the user in a very intuitive manner.

Built-In Scheduler

An unplanned change in an organization's software and databases can be confusing, or even disastrous. Our invention's software analysis can be automatically executed on a pre-defined schedule allowing the user to reduce the risk of unplanned or undesirable changes creeping into his or her systems. Using a user driven model for scheduled collection of system changes, the invention automatically detects changes to targeted data sources. This is done by allowing the user to schedule the collection of change specifications for a particular application as shown in FIG. 9. Once the user sets the scheduling criteria, the task is run accordingly to the schedule.

The software analysis results can be setup with automatic e-mail and paging alarms or dynamically exported to databases, web-site or integrated into reports utilizing the flexibility of automatically generated HTML pages thereby reducing confusion and keeping users up to date.

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. A system connected to multiple heterogeneous data sources each having a data structure, said system monitoring at least one of said data structures, analyzing changes to said at least one of said data structure and providing for simultaneous re-coding of adapters between at least two of said multiple heterogeneous data sources.

2. The system of claim 1 including a system component for monitoring at least one data source and automatically detecting changes in the data structure of said data source.

3. A system connected to multiple heterogeneous data sources each having a data structure, said system monitoring at least two of said data sources to detect similarities within the data structures of said data sources and generating new dynamic adapters to integrate said at least two of said data sources.

4. The process in a system within an integration environment for analyzing changes to multiple heterogeneous data sources each having a data structure and providing for simultaneous re-coding of dynamic adapters between said multiple heterogeneous data sources, including the steps of intelligently analyzing the conceptual relationships and alternative data mapping strategies between a plurality of said data structures by utilizing intelligent computer programs to analyze and adapt to structural, contextual and semantic differences between said multiple heterogeneous data sources.

5. The process of claim 3 wherein said system monitors a plurality of dynamic adapters generated under changing computer environment conditions, said process including the steps of providing real time error validation of said dynamic adapters and performance optimization of at least one of said dynamic adapters.

6. The process of claim 5 including the step of using syntactic processes to automatically create adapter maintenance and support plans.

7. The process of claim 6 wherein the step of using syntactic processes occurs in an App2App Ontology Mapper and a Planner.

8. The process of claim 6 including the step of automatically checking for errors in said dynamic adapter.

9. The system of claim 1 further including error management components for automatically testing said recoded dynamic adapters before they are placed into operation.

10. The process of claim 2 further including the step of generating programming code automatically in response to said automatically detecting changes.

11. The process of claim 6 further including the steps of dynamically detecting changes, including revisions in said at least one data source, analyzing said revisions, generating data structure mapping between heterogeneous data sources, validating errors, and executing appropriate adapter modifications.

12. The process of claim 11 further including the step determining an optimum update for the said dynamic adapters.

13. The system of claim 1 further including models that are jobs, applications, users, change specifications, schemas, applications, ontologies, App2App similarity maps, at least one Common Ontology and at least one database.

14. The system of claim 1 further including system managers for managing system-wide settings and data, schema managers for providing, storing, listing, and deleting schemas, user managers for managing users and their preferences, change specification managers for managing storage and retrieval of change specifications, job managers for managing jobs performing analysis or automation, task managers for managing and running scheduled tasks, ontology managers for mapping the access to and modification of the Common Ontology or other application ontologies, language managers for managing different programming languages in which the system can produce integration adapters.

15. The system of claim 14 wherein each said change specification represents the changes between two specific snapshots of a schema.

16. The system of claim 14 wherein a language manager allows a user to set preferences for delivery of language specific adapters.

17. The system of claim 1 further including an application ontology factory for mapping schemata of a plurality of data sources to the common ontology to produce data source specific ontologies; an App2App Similarity Mapper for mapping a specific data source ontology to another data source ontology and producing a map of potential integration points between the two data sources; an ontology editor functioning both as a manager and a factory; and a Planner for producing an interactive integration plan between two disparate data sources based on the App2App similarity map.

18. The system of claim 17 wherein said ontology editor manages direct human interaction with the common ontology for validation, expansion and modification of said common ontology.

19. The system of claim 18 wherein said ontology editor provides a visual representation of the common ontology.

20. The system of claim 19 wherein said factories produce specific kinds of models.

21. The system of claim 20 wherein said factories manage persistence operations for said models set forth in claim 13.

22. The system of claim 1 further including (a) a Codegen Agent for interacting with a planner, a change specification manager, an App2App ontology factory and external data source-specific settings to generate and adapt integration code, and (b) a deployment agent for interacting with external data source environment elements and a Codegen Agent for deploying code in a self-adapting fashion.

23. The system of claim 22 wherein said Codegen Agent validates said deployed code.

24. The system of claim 22 wherein said components run on a backend server.

25. The system of claim 1 further including a desktop client running on users' or clients' desktops, said desktop capable of making requests of the system server components via system Proxies, receiving data from those requests, and presenting that data to the user, said desktop comprising an Application Context, a Schema Context, a change Specification context, a Report Generation Context, a Task List Context, an Admin Context, a User Administration context, a Notification context, an Application Ontology View context, an App2App Similarity Mapping Context, a Plan View context, a Language editor and a Code Browser context.

26. The system of claim 25 wherein said Application Context lists previously defined data sources and shows detailed information for the selected data source.

27. The system of claim 26 wherein the Application Context allows a user to add, modify or remove data source definitions.

28. The system of claim 25 wherein the Schema context lists previously collected schemas and shows detailed information for a selected schema.

29. The system of claim 25 wherein the Schema context shows detailed information for the selected schema and allows a user to add or remove schemas.

30. The system of claim 25 wherein the Change Specification Context lists the previously created Change Specifications and shows detailed information for the selected change specification.

31. The system of claim 25 wherein the Change Specification Context allows a user to add or remove change specifications.

32. The system of claim 25 wherein the Report Generation Context allows retrieval of previously saved reports.

33. The system of claim 25 wherein the Report Generation Context creates a new report from an existing schema or change specification.

34. The system of claim 25 wherein the Report Generation Context allows a user to save the current report.

35. The system of claim 25 wherein the Task List Context lists the pending/scheduled tasks for the current user and allows said user to add, modify or remove a task.

36. The system of claim 25 wherein the User Administration Context lists users of the system and allows an administrator user to set up new users and administer passwords.

37. The system of claim 26 wherein the Notification Context displays notifications and sets up notification preferences.

38. The system of claim 25 wherein the Application Ontology View Context lists application ontologies and displays application ontologies for browsing.

39. The system of claim 25 wherein the App2App Similarity Mapping Context lists App2App Similarity Maps and displays App2App Similarity Maps for browsing and user acceptance.

40. The system of claim 25 wherein the Plan View Context lists Integration Plans and displays Integration Plans for user browsing and acceptance.

41. The system of claim 25 wherein the Language Editor lists languages supported by the system and displays specific language settings for user browsing and preference selection.

42. The system of claim 25 wherein the Code Browser Context displays code in specific language for user browsing, user saving and user preference settings.

43. The system of claim 1 including a System Hub for providing clients with components that can be used to directly communicate with server components.

44. The system of claim 1 further including software processes comprising an Assessment Micro Agent, an App2App Similarity Mapper, a Planner, a Hub, and Error Validation and Code Generation components.

45. The system of claim 44 wherein said Assessment Micro Agent component comprises a Schema, Change Specification, a Task Manager and a Job Manager.

46. The process of operating on two data sources within a system including other components than said two data sources, said other components including at least a Common Ontology library, including the steps of:
monitoring each of said data sources by an Assessment Micro Agent including a Schema Manager,
said Assessment Micro Agent creating an inventory of the data structures and functionalities of said data sources and making said inventory available to predetermined ones of said other components of said system,
said Assessment Micro Agent detecting a change in either of said data sources and notifying at least some of said other components of the change.

47. The process of claim 46 further including the step of an Application Ontology Factory accepting a data structure inventory from said Schema Manager and information provided from said Common Ontology library to produce data source ontologies.

48. The process of claim 47 including the further step of an App2App Similarity Mapper accepting the information in the data source ontologies to produce a similarity map between the two data sources.

49. The process of claim 48 including the further step of a Planner using the information contained in said similarity map to produce an integration plan.

50. The process of claim 49 including the further step of a CodeGen Agent accepting the information provided in the integration plan and using it to produce integration code.

51. The process of claim 50 including the further steps of validating said integration code by an Error Management Micro Agent and deploying said integration code between the two data sources.

52. The process of claim 46 including the further step of the Schema Manager of said Assessment Micro Agent reading the data structure stored in a data source to produce a schema that is placed into a memory model.

53. The process of claim 52 including the steps of the Schema Manager collecting data source information, data source driver information, table names, table types, indexes, foreign keys, column names, column data types, column precision, column nullability, primary key designation, view definitions, synonym and alias references, and remarks stored in the database schema and providing said collected information to predetermined ones of said other components.

54. The process of claim 46 including the further steps of the Assessment Micro Agent, in response to a change in a monitored data source, detecting alterations including new information in the database structure of said data source and analyzing said change by comparing said new information of said alteration to data stored in the Schema Manager.

55. The process of claim 54 wherein said last named step is performed by the Change Specification Manager comparing one historical view of the schema for one data source to another historical view of said schema.

56. An Assessment Micro Agent comprising a plurality of components including:
a Schema—Manager connected to at least one data source for analyzing said at least one data source and extracting a meta-data model in the form of a schema, storing said schema and providing an interface to certain of said plurality of components for retrieving the schema;
a Change Specification Manager for performing an analysis of what is different between two different versions of a data source by comparing the schemas associated with each version and presenting the change specification file to a user in a structured manner with specific information indicating changes in the schemas;
a Task scheduler for allowing a user to schedule tasks; and
a Notification Manager for providing an interface in which users can define notifications at several levels of granularity.

57. The Assessment Micro Agent of claim 56 wherein said levels of granularity include setting up notifications on the complete file of the change specifications or on filtered views of said files according to user preferences.

58. The Assessment Micro Agent of claim 56 wherein the Notification Manager can send notifications via standard mediums such as email, pager or PDAs according to user preferences.

59. The Assessment Micro Agent of claim 56 wherein the tasks include the generation of schemas through the Schema Manager and the generation of change specifications through the Change Specification Manager.

60. The Assessment Micro Agent of claim 56 further including the functions of monitoring connectivity between the Assessment Micro Agent and said data sources, managing the schema monitoring, retrieving change specifications, sending system-level notifications and user notifications, and allowing a user to create filtered views of changes according to one or more user preferences.

61. The process of operating an Application Ontology Factory including the steps of:
converting the schema obtained from the Schema Manager component of the Assessment Micro Agent into a language compatible to the Common Ontology;
mapping schema element identifiers to a WordNet to extract at least one of the senses of said elements;
using said senses to extract all possible Common Ontology concept hierarchies to which the element might be a top-most specialization;
assigning each concept hierarchy a confidence factor;
merging said concept hierarchies to produce a micro-theory including each of said senses.

62. The process of claim 61 wherein a schema element is associated with one or more concept hierarchies.

63. The process of claim 62 wherein each concept hierarchy has an independent confidence factor.

64. In an artificial intelligence system connected to multiple heterogeneous data sources for generating new dynamic adapters to integrate changes in at least two of said data sources, the process of describing a schema using the syntax of the Common Ontology language.

65. In a system for automatically re-coding interfaces between heterogeneous data sources the process of monitoring changes in a monitored data source, analyzing the exact nature of the change, evaluating alternative data mapping possibilities, and adjusting the existing dynamic adapter integration code structures to address the changes.

66. The process of claim 65 including the step of using synonym relations for lexical level mapping by computing lexical proximity of elements in the schemas of the data sources.

67. The process of claim 65 including the step of finding semantical proximity by using hypernym relationships.

68. The process of claim 65 including the step of using computing the closeness of data values on mapped schema elements.

69. In a system for automatically generating dynamic adapters between heterogeneous data sources the process of monitoring changes in a monitored data source using pattern matching, said process including the steps of:
generating a data source to ontology mapping for each data source being mapped by evaluating the mathematical probabilities of lexical and semantic relationships between schema entities and ontology concepts;
determining lexical closeness between the data source ontology and Common Ontology concepts using synonym relationships;
determining mathematical closeness of semantic relationships in the form of hypernyms; and
determining confidence factors based on the mathematical probability of said data source ontology and said Common Ontology being lexically and semantically close.

70. The process of claim 69 including the further steps of:
comparing the data source ontologies of the monitored data sources to determine common concepts;
mapping a data source ontology to another data source ontology using synonym and hypernym relationships;
extracting a sample of data element values from each said data sources and comparing said data element values to determine mathematical closeness;
validating expected data values for said data source ontology mappings;
composing and decomposing semantic relationships between target and source data source ontology elements; and
uniting semantically similar schema elements into new ontology concepts.

71. The process of claim 70 wherein the step of validating mappings using expected data values includes the step of validating said closeness by performing pattern matching on the data values of one data source data element and another data source data element by determining how close data values for said elements are.

72. The process of claim 71 including the step of using pattern-matching to normalize data properties of the data structures of the data sources including data type and data length.

73. The process of claim 70 wherein the step of composing semantic relationships includes the steps of comparing data values of data source data structure elements and deriving semantic similarity thereof based on semantic proximity of one data source's data structure elements to another data source's data structure elements.

74. The process of claim 70 wherein the step of decomposing semantic relationships includes the steps of:
determining that two data structure elements are similar;
determining that one of said data structures has data elements with no associated functional relationship and that said other data structure element has a functional relationship with other data structure elements;
determining whether said data elements display any similarity with said other data structure elements.

75. The process of claim 70 wherein the step of uniting data structure elements to form a new concept in the Common Ontology includes the step of mapping two or more different data structure elements from a data source to another data source by determining whether the mapped-to concept in the Common Ontology is the most specialized concept of a concept hierarchy in the Common Ontology and has no children concept, and adding said data structure as a concept to the Common Ontology.

76. In a system for automatically generating dynamic adapters between heterogeneous data sources, a Planner receiving the change specification file created by the Change Specification Manager and developing and logically testing an ordered dynamic adapter development plan.

77. In a system for automatically generating dynamic adapters between heterogeneous data sources, a Planner receiving a similarity map file created by an App2App Similarity Mapper and developing and logically testing an ordered dynamic adapter development plan.

78. The Planner of claim 77, said Planner being a software component for performing the process steps of (a) using a planning engine to evaluate confidence factors determined by an App2App Similarity Mapper and selecting higher confidence factors as planning goals and (b) determining the required data transformation steps that need to occur in order to accomplish said goals.

79. The Planner of claim 78 wherein the mappings having a confidence factor of 100% are provided to a user as planning goals with high degree of confidence and mappings with less than 100% confidence factors produce a plurality of alternative mapping goals.

80. The Planner of claim 79 including a software process responsive to said planning goals to produce the required data transformation steps to accomplish said planning goals.

81. An App2App Ontology Mapper for producing data mapping between schema elements, said mappings having confidence factors, said App2App Ontology Mapper including a software process for detecting that said mapping is accomplished by a lexical, semantic, expected data value, composition or decomposition process and, responsive to any such detecting, increasing said confidence factor.

82. An App2App Ontology Mapper for producing data mapping between schema elements, said mappings having confidence factors, said App2App Ontology Mapper including a software process for detecting that said mapping is refuted by a lexical, semantic, expected data value, composition or decomposition process and, responsive to any such detecting, lowering said confidence factor.

83. An App2App Ontology Mapper for producing data mappings between schema elements, said mappings having confidence factors, said App2App Ontology Mapper including a software process for assigning a lower confidence factor to mappings accomplished by lexical similarity than to mappings accomplished by lexical similarity plus semantic mapping.

84. An App2App Ontology Mapper for producing data mappings between schema elements, said mappings having confidence factors, said App2App Ontology Mapper including a software process for assigning a lower confidence factor to mappings accomplished by semantic mapping than to mappings accomplished by semantic mapping and expected data value mapping.

85. In a system for generating dynamic adapters between changed data sources, a process for generating dynamic adapters including the steps of:
after an integration plan between two data sources has been generated, an Assessment Micro Agent determining that one of said data source's data structure has changed and, in response to said detecting, informing a Planner software component to generate a new plan if the previously generated plan has been affected by said change;
creating a Change Specification File that describes said changes that occurred;
discovering which schema elements of said dynamic adapter have changed;
mapping the affected schema elements into the existing data source ontology;
performing lexical and semantic mapping on the affected schema elements to find new associations with said data source ontology;
in response to finding said new associations, validating said new associations; and
attempting to find new mappings for the affected elements.

86. The process of claim 85 wherein said attempting to find new mappings is accomplished using an expected data value process.

87. The process of claim 85 including the further step of in response to finding no said mappings, attempting to find new mappings using composition and decomposition processes.

88. The process of claim 85 including the step of producing a new map and presenting said new map to a user.

89. The process of claim 88 including the step of detecting an indication that said user accepts said new map and, in response to said detecting of said indication, providing the map to the Planner.

90. The process of claim 89 wherein said Planner generates the new plan, said plan having confidence factors associated therewith.

91. In a system for generating revised dynamic adapters between changed data sources, a process for revising said adapters including the steps of:
a Planner presenting an integration plan approved by a user as input to a CodeGen Agent;
said CodeGen Agent executing the development of new adapters by reparsing said integration plan into a user-selected programming language.

92. The process of claim 91 wherein said reparsing is accomplished using a template file that contains transformation instructions to translate each integration operation into compilation-ready source code for the selected adapter language.

93. In a system for generating new dynamic adapters between data sources, a process for generating said adapters including the steps of:
a Planner presenting as input to a CodeGen Agent an integration plan approved by a user, said integration plan including an indication of a use-selected programming language;
said CodeGen Agent executing the development of new adapters by producing programming instructions to accomplish the integration plan in the user-elected programming language.

94. For use in a system for generating new dynamic adapters between data sources, an Error Management Micro Agent coupled to a Planner and accepting the output from said Planner to determine and categorize program errors and remediation plans.

95. The Error Management Micro Agent of claim 94 including a software process capable of detecting errors in one or more of the group consisting of generated code, data extraction, data aggregation and data insertion.

96. The Error Management Micro Agent of claim 95 wherein said detecting errors in said generated code is accomplished by using compiler and script verification technology.

97. The Error Management Micro Agent of claim 95 wherein detecting errors in data extraction, data aggregation and data insertion is accomplished by detecting one or more errors in the logical correctness of the generated code.

98. The Error Management Agent of claim 97 wherein the step of detecting one or more errors in the logical correctness of the code is accomplished by (a) use of a database emulator to emulate database tasks and, (b) comparing the results of the emulations against said plan presented by said Planner.

99. A system for automatically re-coding interfaces between heterogeneous data sources comprising:
means for monitoring modifications made to a data source existing within an integration environment, wherein the environment contains multiple heterogeneous data sources,
means for analyzing said modifications,
means for formulating a set of potential ontological mappings between heterogeneous data sources,
means for providing interoperability code structures between heterogeneous data sources.

100. The system of claim 99, wherein the system is additionally comprised of a means for error detection.

101. A system for automatically re-coding interfaces between heterogeneous data sources comprising:
means for monitoring and analyzing modification made to a data source existing within an integration environment, wherein the environment contains multiple heterogeneous data sources;
means for formulating a set of potential ontological mappings between heterogeneous data sources and providing interoperability code structures between data sources.

102. In a system for automatically generating dynamic adapters between heterogeneous data sources the process of generating a new adapter, said process including the steps of:
generating a data source to ontology mapping for each data source being mapped by evaluating the mathematical probabilities of lexical and semantic relationships between schema entities and ontology concepts;
determining lexical closeness between the data source ontology and Common Ontology concepts using synonym relationships;
determining mathematical closeness of semantic relationships in the form of hypernyms;
determining confidence factors based on the mathematical probability of said data source ontology and said Common Ontology being lexically and semantically close.

103. The process of claim 102 including the further steps of:
comparing the data source ontologies of the monitored data sources to determine common concepts;
mapping a data source ontology to another data source ontology using synonym and hypernym relationships;
extracting a sample of data element values from each said data sources and comparing said data element values to determine mathematical closeness;
validating expected data values for said data source ontology mappings;
composing and decomposing semantic relationships between target and source data source ontology elements; and
uniting semantically similar schema elements into new ontology concepts.

104. The process of claim 103 wherein the step of validating mappings using expected data values includes the step of validating said closeness by performing pattern matching on the data values of one data source data element and another data source data element by determining how close data values for said elements are.

105. The process of claim 104 including the step of using pattern-matching to normalize data properties of the data structures of the data sources including data type and data length.

106. The process of claim 103 wherein the step of composing semantic relationships includes the steps of comparing data values of data source data structure elements and deriving semantic similarity thereof based on semantic proximity of one data source's data structure elements to another data source's data structure.

107. The process of claim 103 wherein the step of decomposing semantic relationships includes the steps of:
determining that two data structure elements are similar;
determining that one of said data structures has data elements with no associated functional relationship and that said other data structure element has a functional relationship with other data structure elements;
determining whether said data elements display any similarity with said other data structure elements.

108. The process of claim 103 wherein the step of uniting data structure elements to form a new concept in the Common Ontology includes the step of mapping two or more different data structure elements from a data source to another data source by determining whether the mapped-to concept in the Common Ontology is the most specialized concept of a concept hierarchy in the Common Ontology and has no children concept, and adding said data structure as a concept to the Common Ontology.

109. The Planner of claim 76, said Planner being a software component for performing the process steps of (a) using a planning engine to evaluate confidence factors determined by an App2App Similarity Mapper and selecting higher confidence factors as planning goals and (b) determining the required data transformation steps that need to occur in order to accomplish said goals.

110. The Planner of claim 109 wherein the mappings having a confidence factor of 100% are provided to a user as planning goals with high degree of confidence and mappings with less than 100% confidence factors produce a plurality of alternative mapping goals.

111. The Planner of claim 110 including a software process responsive to said planning goals to produce the required data transformation steps to accomplish said planning goals.

112. In a system for generating dynamic adapters between two data sources, a process for developing dynamic adapters including the steps of:
before an integration plan between said two data sources has been generated, an App2App Similarity Mapper determining the similarities between said two data sources and informing a Planner software component to generate a new plan, said App2App Similarity Mapper performing at least the steps of:
creating an App2App similarity map that describes said similarities;
mapping the schema elements affected by said similarities to an existing data source ontology;
performing lexical and semantic mapping on the affected schema elements to find new associations with said data source ontology;
in response to finding said new associations, validating said new associations; and
attempting to find new mappings for the affected elements.

113. The process of claim 112 wherein said attempting to find new mappings is accomplished using an expected data value process.

114. The process of claim 112 including the further step of in response to finding no said mappings, attempting to find new mappings using composition and decomposition processes.

115. The process of claim 112 including the step of producing a new map and presenting said new map to a user.

116. The process of claim 115 including the step of detecting an indication that said user accepts said new map and, in response to said detecting of said indication, providing the map to the Planner.

117. The process of claim 116 wherein said Planner generates the new plan, said plan having confidence factors associated therewith.

118. One or more processor readable storage devices having processor readable code embodied on said processor readable storage devices, said processor readable code for programming one or more processors to perform in a system within an integration environment for analyzing changes to multiple heterogeneous data sources each having a data structure and providing for simultaneous re-coding of dynamic adapters between said multiple heterogeneous data sources, the process comprising the step of intelligently analyzing the conceptual relationships and alternative data mapping strategies between a plurality of said data structures by utilizing intelligent computer programs to analyze and adapt to structural, contextual and semantic differences between said multiple heterogeneous data sources.

119. The one or more processor readable storage devices of claim 118 wherein said system monitors a plurality of dynamic adapters generated under changing computer environment conditions where said process includes the further steps of providing real time error validation of said dynamic adapters and performance optimization of at least one of said dynamic adapters.

120. The one or more processor readable storage devices of claim 119 where said process includes the further step of using syntactic processes to automatically create adapter maintenance and support plans.

121. The one or more processor readable storage devices of claim 120 where said process includes the further step of using syntactic processes occurs in an App2App Ontology Mapper and a Planner.

122. The one or more processor readable storage devices of claim 121 where said process includes the further step of automatically checking for errors in said dynamic adapter.

123. One or more processor readable storage devices having processor readable code embodied on said processor readable storage devices, said processor readable code for programming one or more processors to perform a process of operating on two data sources within a system including other components than said two data sources, said other components including at least a Common Ontology library, the process comprising the steps of:
monitoring each of said data sources by an Assessment Micro Agent including a Schema Manager;
said Assessment Micro Agent creating an inventory of the data structures and functionalities of said data sources and making said inventory available to predetermined ones of said other components of said system;
said Assessment Micro Agent detecting a change in either of said data sources and notifying at least some of said other components of the change.

124. The one or more processor readable storage devices of claim 123 where said process includes the further step of an Application Ontology Factory accepting a data structure inventory from said Schema Manager and information provided from said Common Ontology library to produce data source ontologies.

125. The one or more processor readable storage devices of claim 124 where said process includes the further step of an App2App Similarity Mapper accepting the information in the data source ontologies to produce a similarity map between the two data sources.

126. The one or more processor readable storage devices of claim 125 where said process includes the further step of a Planner using the information contained in said similarity map to produce an integration plan.

127. The one or more processor readable storage devices of claim 126 where said process includes the further step of a CodeGen Agent accepting the information provided in the integration plan and using it to produce integration code.

128. The one or more processor readable storage devices of claim 127 where said process includes the further step of validating said integration code by an Error Management Micro Agent and deploying said integration code between the two data sources.

129. The one or more processor readable storage devices of claim 123 where said process includes the further step of the Schema Manager of said Assessment Micro Agent reading the data structure stored in a data source to produce a schema that is placed into a memory model.

130. The one or more processor readable storage devices of claim 129 where said process includes the further step of the Schema Manager collecting data source information, data source driver information, table names, table types, indexes, foreign keys, column names, column data types, column precision, column nullability, primary key designation, view definitions, synonym and alias references, and remarks stored in the database schema and providing said collected information to predetermined ones of said other components.

131. The one or more processor readable storage devices of claim 123 where said process includes the further step of the Assessment Micro Agent, in response to a change in a monitored data source, detecting alterations including new information in the database structure of said data source and analyzing said change by comparing said new information of said alteration to data stored in the Schema Manager.

132. One or more processor readable storage devices having processor readable code embodied on said processor readable storage devices, said processor readable code for programming one or more processors to perform a process of operating an Application Ontology Factory, the process comprising the steps of:
converting the schema obtained from the Schema Manager component of the Assessment Micro Agent into a language compatible to the Common Ontology;
mapping schema element identifiers to a WordNet to extract at least one of the senses of said elements;
using said senses to extract all possible Common Ontology concept hierarchies to which the element might be a top-most specialization;
assigning each concept hierarchy a confidence factor;
merging said concept hierarchies to produce a micro-theory including each of said senses.

133. The one or more processor readable storage devices of claim 132 wherein schema element is associated with one or more concept hierarchies.

134. The one or more processor readable storage devices of claim 133 wherein each concept hierarchy has an independent confidence factor.

135. One or more processor readable storage devices having processor readable code embodied on said processor readable storage devices, said processor readable code for programming one or more processors to perform a process, in an artificial intelligence system connected to multiple heterogeneous data sources for generating new dynamic adapters to integrate changes in at least two of said data sources, the process of describing a schema using the syntax of the Common Ontology language.

136. One or more processor readable storage devices having processor readable code embodied on said processor readable storage devices, said processor readable code for programming one or more processors to perform a process, in a system for automatically recoding interfaces between heterogeneous data sources, the process comprising the step of monitoring changes in a monitored data source, analyzing the exact nature of the change, evaluating alternative data mapping possibilities, and adjusting the existing dynamic adapter integration code structures to address the changes.

137. The one or more processor readable storage devices of claim 136 where said process includes the further step of using synonym relations for lexical level mapping by computing lexical proximity of elements in the schemas of the data sources.

138. One or more processor readable storage devices having processor readable code embodied on said processor readable storage devices, said processor readable code for programming one or more processors to perform, in a system for automatically generating dynamic adapters between heterogeneous data sources, the process of monitoring changes in a monitored data source using pattern matching, the process comprising the steps of:
generating a data source to ontology mapping for each data source being mapped by evaluating the mathematical probabilities of lexical and semantic relationships between schema entities and ontology concepts;
determining lexical closeness between the data source ontology and Common Ontology concepts using synonym relationships;
determining mathematical closeness of semantic relationships in the form of hypernyms; and
determining confidence factors based on the mathematical probability of said data source ontology and said Common Ontology being lexically and semantically close.

139. The one or more processor readable storage devices of claim 138 where said process includes the further steps of:
comparing the data source ontologies of the monitored data sources to determine common concepts;
mapping a data source ontology to another data source ontology using synonym and hypernym relationships;
extracting a sample of data element values from each said data sources and comparing said data element values to determine mathematical closeness;
validating expected data values for said data source ontology mappings;
composing and decomposing semantic relationships between target and source data source ontology elements; and
uniting semantically similar schema elements into new ontology concepts.

140. One or more processor readable storage devices having processor readable code embodied on said processor readable storage devices, said processor readable code for programming one or more processors to perform a process in a system for automatically generating dynamic adapters between heterogeneous data sources, the process comprising the step of a Planner receiving the change specification file created by the Change Specification Manager and developing and logically testing an ordered dynamic adapter development plan.

141. One or more processor readable storage devices having processor readable code embodied on said processor readable storage devices, said processor readable code for programming one or more processors to perform a process, in a system for automatically generating dynamic adapters between heterogeneous data sources, the process comprising the step of a Planner receiving a similarity map file created by an App2App Similarity Mapper and developing and logically testing an ordered dynamic adapter development plan.

142. One or more processor readable storage devices having processor readable code embodied on said processor readable storage devices, said processor readable code for programming one or more processors to perform a process in a system for generating dynamic adapters between changed data sources, said process for generating dynamic adapters including the steps of:
after an integration plan between two data sources has been generated, an Assessment Micro Agent determining that one of said data source's data structure has changed and, in response to said detecting, informing a Planner software component to generate a new plan if the previously generated plan has been affected by said change;
creating a Change Specification File that describes said changes that occurred;
discovering which schema elements of said dynamic adapter have changed;
mapping the affected schema elements into the existing data source ontology;
performing lexical and semantic mapping on the affected schema elements to find new associations with said data source ontology;
in response to finding said new associations, validating said new associations; and
attempting to find new mappings for the affected elements.

143. The one or more processor readable storage devices of claim 142 wherein said attempting to find new mappings is accomplished using an expected data value process.

144. The one or more processor readable storage devices of claim 142 where said process includes the further step of in response to finding no said mappings, attempting to find new mappings using composition and decomposition processes.

145. The one or more processor readable storage devices of claim 142 where said process includes the further step of producing a new map and presenting said new map to a user.

146. One or more processor readable storage devices having processor readable code embodied on said processor readable storage devices, said processor readable code for programming one or more processors to perform, in a system for generating revised dynamic adapters between changed data sources, a process for revising said adapters the process comprising the steps of:
a Planner presenting an integration plan approved by a user as input to a CodeGen Agent;
said CodeGen Agent executing the development of new adapters by reparsing said integration plan into a user-selected programming language.

147. The one or more processor readable storage devices of claim 146 wherein said reparsing is accomplished using a template file that contains transformation instructions to translate each integration operation into compilation-ready source code for the selected adapter language.

148. One or more processor readable storage devices having processor readable code embodied on said processor readable storage devices, said processor readable code for programming one or more processors to perform, in a system for generating new dynamic adapters between data sources, a process for generating said adapters, the process comprising the steps of:
a Planner presenting as input to a CodeGen Agent an integration plan approved by a user, said integration plan including an indication of a use-selected programming language;
said CodeGen Agent executing the development of new adapters by producing programming instructions to accomplish the integration plan in the user-elected programming language.

149. One or more processor readable storage devices having processor readable code embodied on said processor readable storage devices, said processor readable code for programming one or more processors to perform, in a system for automatically generating dynamic adapters between heterogeneous data sources the process of generating a new adapter, the process comprising the steps of:
generating a data source to ontology mapping for each data source being mapped by evaluating the mathematical probabilities of lexical and semantic relationships between schema entities and ontology concepts;
determining lexical closeness between the data source ontology and Common Ontology concepts using synonym relationships;
determining mathematical closeness of semantic relationships in the form of hypernyms;
determining confidence factors based on the mathematical probability of said data source ontology and said Common Ontology being lexically and semantically close.

150. The one or more processor readable storage devices of claim 149 where said process includes the further steps of:
comparing the data source ontologies of the monitored data sources to determine common concepts;
mapping a data source ontology to another data source ontology using synonym and hypernym relationships;
extracting a sample of data element values from each said data sources and comparing said data element values to determine mathematical closeness;
validating expected data values for said data source ontology mappings;
composing and decomposing semantic relationships between target and source data source ontology elements; and
uniting semantically similar schema elements into new ontology concepts.

151. One or more processor readable storage devices having processor readable code embodied on said processor readable storage devices, said processor readable code for programming one or more processors to perform, in a system for generating dynamic adapters between two data sources, a process for developing dynamic adapters, the process comprising the steps of:
before an integration plan between said two data sources has been generated, an App2App Similarity Mapper determining the similarities between said two data sources and informing a Planner software component to generate a new plan, said App2App Similarity Mapper performing at least the steps of:
creating an App2App similarity map that describes said similarities;
mapping the schema elements affected by said similarities to an existing data source ontology;
performing lexical and semantic mapping on the affected schema elements to find new associations with said data source ontology;
in response to finding said new associations, validating said new associations; and
attempting to find new mappings for the affected elements.

152. The one or more processor readable storage devices of claim 151 wherein said attempting to find new mappings is accomplished using an expected data value process.

153. The one or more processor readable storage devices of claim 151 where said process includes the further step of, in response to finding no said mappings, attempting to find new mappings using composition and decomposition processes.

154. A process of managing revision in a data source including the steps of:
connecting an Assessment Micro Agent to a data source;
using the Schema Manager, extracting information about the data source;
using the Schema Manager, building a schema of the data source from at least some of said extracted information; and
presenting the schema to a user.

155. The process of claim 154 including the additional steps of:
the user selecting schema elements of interest to the user and creating a filtered view thereof; and
the user using the Task Manager to schedule frequency for generating schema specifications.

156. The process of claim 155 including the additional steps of:
the Change Specification Manager identifying a change in any of the selected schema elements during running of said data source; and
in response to said identifying, informing the user of said detected change.

157. The process of claim 154 wherein the step of collecting information includes the step of collecting data source information, connectivity driver information, table names and types, indexes, primary keys, foreign keys, column names and types, column precision, view definitions, synonym and alias references, and remarks stored in a database schema.
